(19) United States
(12) Patent Application Publication
(10) Pub. No.: US 2017/0193187 A1
(43) Pub. Date: Jul. 6, 2017

(54) MEDICATION HISTORY INFORMATION MANAGEMENT DEVICE AND METHOD, REGISTRATION TERMINAL DEVICE AND METHOD, AND PROGRAM

(71) Applicant: SONY CORPORATION, TOKYO (JP)

(72) Inventors: RYU NARUSAWA, KANAGAWA (JP); YOSHINORI TAKAGI, KANAGAWA (JP); GAKUHO FUKUSHI, TOKYO (JP)

(21) Appl. No.: 15/315,617

(22) PCT Filed: Jun. 11, 2015
(86) PCT No.: PCT/JP2015/066828

§ 371 Date: Dec. 1, 2016

(30) Foreign Application Priority Data
Jun. 24, 2014 (JP) 2014-128838

(51) Int. Cl. G06F 19/00

(52) U.S. Cl. CPC G06F 19/3456; G06F 19/322

(57) ABSTRACT

The present technology relates to a medication history information management device and a method, a registration terminal device and a method, and a program that are designed to improve convenience of use while maintaining security. When there is a request for registration of a mobile terminal device, a data center associates an individual-based terminal ID for identifying the mobile terminal device with a personal identification ID for identifying the user, and records the individual-based terminal ID. The data center also associates registration date information and organization information with the individual-based terminal ID, and records the registration date information and the organization information. For the newly registered mobile terminal device, the data center further generates registration notification information in accordance with the registration date information and the organization information, and transmits the registration notification information to a member store terminal device. The member store terminal device displays the registration notification information received from the data center. The present technology can be applied to information processing devices.

### CROSS REFERENCE TO RELATED APPLICATIONS

This application is a U.S. National Phase of International Patent Application No. PCT/JP2015/066828 filed on Jun. 11, 2015, which claims priority benefit of Japanese Patent Application No. JP 2014-128838 filed in the Japan Patent Office on Jun. 24, 2014. Each of the above-referenced applications is hereby incorporated herein by reference in its entirety.

### TECHNICAL FIELD

The present technology relates to a medication history information management device and a method, a registration terminal device and a method, and a program. More particularly, the present technology relates to a medication history information management device and a method, a registration terminal device and a method, and a program that are designed to improve convenience of use while maintaining security.

### BACKGROUND ART

There have been known services and the like that manage various kinds of data with servers and enable individual users to view the data, for example. The data to be viewed is considered to be various kinds of data, such as medication history data of a user. If the data to be viewed is personal data, the personal information and the like about the user should be appropriately used to confirm the user's identity.

Normally, personal information is tightly guarded once obtained. However, this entails high management costs for related data.

To counter this, there are a suggested mechanism for recording no personal information on the server side, and a suggested mechanism for transmitting personal information directly to the mobile terminal device side with a quick response (QR) code (a registered trade name) (see Patent Document 1, for example).

There also is a suggested technique by which terminal IDs, telephone numbers, and the like attached beforehand to respective mobile terminal devices are registered on the server side so that the mobile terminal devices can be granted viewing permissions (see Patent Document 2, for example). This technique ensures uniqueness of each mobile terminal device in a server, and enables a user to designate a mobile terminal device to cancel a subscription to a service.

### CITATION LIST

### Patent Documents

Patent Document 1: Japanese Patent Application Laid-Open No. 2013-101585
Patent Document 2: Japanese Patent Application Laid-Open No. 2007-164449

### SUMMARY OF THE INVENTION

### Problems to be Solved by the Invention

By the above described technique, however, it is difficult to improve convenience of use while maintaining security in a case where not only a user but also other persons such as the user's family members are to view the user's personal data that is managed by a server.

For example, by the technique disclosed in Patent Document 1, in a case where a user records personal information in mobile terminal devices and views the data being managed by a server, it is not possible to distinguish the mobile terminal devices from one another on the server's side. Therefore, it is difficult for the user to manage viewing permissions, because the user needs to check which mobile terminal device(s) is (are) allowed to view the data, for example.

Meanwhile, by the technique disclosed in Patent Document 2, a user can designate a mobile terminal device to cancel a subscription to a service, but the terminal ID or the telephone number of the mobile telephone needs to be recorded beforehand on the server side. The terminal IDs and the telephone numbers unique to such mobile terminal devices are now being regarded as the information closest to personal information, which is inconvenient in achieving a mechanism that does not supply personal information to the server side.

The present technology has been developed in view of those circumstances, and is to improve convenience of use while maintaining security.

### Solutions to Problems

A medication history information management device according to a first aspect of the present technology is a medication history information management device connected to registration terminal devices and viewing terminal devices via a communication network,

the medication history information management device including:

a communication unit that transmits and receives information;

a recording unit that records at least medication history information and terminal identification information about a viewing terminal device allowed to view the medication history information, the medication history information and the terminal identification information being associated with personal identification information; and

a control unit that controls the communication unit and the recording unit,

wherein,

when the communication unit receives, from the registration terminal device, the personal identification information, registration-related information, and a request for registration of a first viewing terminal device as a viewing terminal device allowed to view the medication history information associated with the personal identification information,

the control unit performs:

a process of generating first terminal identification information for identifying the first viewing terminal device;

a process of associating the first terminal identification information and the registration-related information with the personal identification information, and recording the first terminal identification information and the registration-related information into the recording unit; and

a process of transmitting response information including the first terminal identification information from the communication unit to the registration terminal device, the response information indicating that the first viewing terminal device is registered as a viewing terminal device allowed to view the medication history information associated with the personal identification information, and,

when the communication unit receives a request for viewing of the medication history information from a second viewing terminal device, the control unit performs a process of transmitting the medication history information with which the second viewing terminal device is associated as a viewing terminal device allowed to view the medication history information, the medication history information being transmitted from the communication unit to the second viewing terminal device.

The registration-related information may include identification information corresponding to a place where the registration request has been issued by operating the registration terminal device, the identification information being generated as information about a place where the first viewing terminal device has been registered.

When the communication unit receives a request for registration of information about the first viewing terminal device registered in the recording unit in accordance with the registration request, the control unit may perform a process of associating the received information about the first viewing terminal device with the first terminal identification information associated and recorded with the personal identification information, and recording the information about the first viewing terminal device into the recording unit.

The information about the first viewing terminal device may include information from which the owner of the first viewing terminal device can be identified.

In a case where second terminal identification information for identifying the second viewing terminal device is associated with the personal identification information, a viewing terminal device allowed to view the medication history information associated with the personal identification information is newly registered, information indicating that the second viewing terminal device is a viewing terminal device issuing a notification of the new registration of the viewing terminal device is recorded in the recording unit, and when the second viewing terminal device further accesses the communication unit,

the control unit may perform a process of transmitting registration notification information about the viewing terminal device registered as a viewing terminal device allowed to view the medication history information associated with the personal identification information, the registration notification information being transmitted from the communication unit to the second viewing terminal device.

When the communication unit receives the personal identification information, the registration-related information, and a request for registration of the first viewing terminal device as a viewing terminal device allowed to view the medication history information associated with the personal identification information,

the control unit may further perform:

a process of generating registration date information; and

a process of associating the registration date information with the personal identification information, and recording the registration date information into the recording unit.

The registration notification information may include the registration-related information and the registration date information.

When a request for updating of the medication history information associated with the personal identification information is received from the registration terminal device,

the control unit may perform:

a process of updating the medication history information associated with the personal identification information; and

a process of transmitting registration notification information indicating that the first viewing terminal device is associated with the first terminal identification information and is registered, the registration notification information being transmitted from the communication unit to the registration terminal device.

The control unit may further perform

a process of recording, into the recording unit, information indicating whether the registration notification information has been transmitted, and,

when the registration notification information has been transmitted to the registration terminal device, the control unit may update the information indicating whether the registration notification information has been transmitted.

When the communication unit receives a request for invalidation of the right of the first viewing terminal device to view the medication history information associated with the personal identification information, the control unit may perform a process of invalidating the right of the first viewing terminal device to view the medication history information.

The control unit may perform the process of invalidating the right of the first viewing terminal device to view the medication history information by changing information indicating permission/prohibition of viewing by the first viewing terminal device, the information being recorded and associated with the personal identification information.

When the communication unit receives a request for transmission of a list of information about the viewing terminal device associated with the personal identification information, the control unit may perform a process of transmitting, from the communication unit, the list of the information about the viewing terminal device associated with the personal identification information.

A medication history information management method or a program according to the first aspect of the present technology is a medication history information management method or a program in a medication history information management device connected to registration terminal devices and viewing terminal devices via a communication network,

the medication history information management device including:

a communication unit that transmits and receives information; and

a recording unit that records at least medication history information and terminal identification information about a viewing terminal device allowed to view the medication history information, the medication history information and the terminal identification information being associated with personal identification information,

the medication history information management method or the program including the steps of:

when the communication unit receives, from the registration terminal device, the personal identification information, registration-related information, and a request for registration of a first viewing terminal device as a viewing terminal device allowed to view the medication history information associated with the personal identification information,

performing a process of generating the terminal identification information for identifying the first viewing terminal device;

performing a process of associating the terminal identification information and the registration-related information with the personal identification information, and recording the terminal identification information and the registration-related information into the recording unit; and

performing a process of transmitting response information containing the terminal identification information from the communication unit to the registration terminal device, the response information indicating that the first viewing terminal device is registered as a viewing terminal device allowed to view the medication history information associated with the personal identification information; and,

when the communication unit receives a request for viewing of the medication history information from a second viewing terminal device,

performing a process of transmitting the medication history information with which the second viewing terminal device is associated as a viewing terminal device allowed to view the medication history information, the medication history information being transmitted from the communication unit to the second viewing terminal device.

In the first aspect of the present technology,

a medication history information management device is connected to registration terminal devices and viewing terminal devices via a communication network, and includes:

a communication unit that transmits and receives information;

a recording unit that records at least medication history information and terminal identification information about a viewing terminal device allowed to view the medication history information, the medication history information and the terminal identification information being associated with personal identification information; and

a control unit that controls the communication unit and the recording unit.

When the communication unit receives, from the registration terminal device, the personal identification information, registration-related information, and a request for registration of a first viewing terminal device as a viewing terminal device allowed to view the medication history information associated with the personal identification information,

the following processes are performed:

a process of generating first terminal identification information for identifying the first viewing terminal device, a process of associating the first terminal identification information and the registration-related information with the personal identification information, and recording the first terminal identification information and the registration-related information into the recording unit, and

a process of transmitting response information including the first terminal identification information from the communication unit to the registration terminal device, the response information indicating that the first viewing terminal device is registered as a viewing terminal device allowed to view the medication history information associated with the personal identification information.

When the communication unit receives a request for viewing of the medication history information from a second viewing terminal device, a process is performed to transmit the medication history information with which the second viewing terminal device is associated as a viewing terminal device allowed to view the medication history information, the medication history information being transmitted from the communication unit to the second viewing terminal device.

A registration terminal device according to a second aspect of the present technology is a registration terminal device connected to a medication history information management device via a communication network,

the registration terminal device including:

a communication unit that transmits and receives information via the communication network; and

a control unit that controls the communication unit,

wherein the control unit performs:

a process of transmitting first personal identification information, registration-related information, and a request for registration of a first viewing terminal device as a viewing terminal device allowed to view medication history information associated with the first personal identification information, the transmission being from the communication unit to the medication history information management device; and

a process of receiving response information including terminal identification information from the medication history information management device, and displaying the terminal identification information, the response information indicating that the first viewing terminal device is registered in response to the request as a viewing terminal device allowed to view the medication history information associated with the first personal identification information.

The control unit may perform a process of transmitting second personal identification information and a request for viewing or updating of the medication history information associated with the second personal identification information, the transmission being from the communication unit to the medication history information management device, and

when registration notification information about a second viewing terminal device associated with the second personal identification information is received from the medication history information management device in response to the request for viewing or updating,

the control unit may perform:

a process of displaying the registration notification information about the second viewing terminal device; and

a process of transmitting information about the second viewing terminal device to the medication history information management device, or recording the information about the second viewing terminal device into a source of the second personal identification information.

A registration method or a program according to the second aspect of the present technology is a registration method or a program in a registration terminal device that is connected to a medication history information management device via a communication network and includes a communication unit that transmits and receives information via the communication network,

the registration method or the program including the steps of:

performing a process of transmitting personal identification information, registration-related information, and a request for registration of a predetermined viewing terminal device as a viewing terminal device allowed to view medication history information associated with the personal identification information, the transmission being from the communication unit to the medication history information management device; and

performing a process of receiving response information including terminal identification information from the medication history information management device, and displaying the terminal identification information, the response information indicating that the predetermined viewing terminal device is registered in response to the request as a viewing terminal device allowed to view the medication history information associated with the personal identification information.

In the second aspect of the present technology,

a registration terminal device is connected to a medication history information management device via a communication network, and includes:

a communication unit that transmits and receives information via the communication network; and

a control unit that controls the communication unit.

In the registration terminal device,

a process is performed to transmit first personal identification information, registration-related information, and a request for registration of a first viewing terminal device as a viewing terminal device allowed to view medication history information associated with the first personal identification information, the transmission being from the communication unit to the medication history information management device, and

a process is performed to receive response information including terminal identification information from the medication history information management device, and display the terminal identification information, the response information indicating that the first viewing terminal device is registered in response to the request as a viewing terminal device allowed to view the medication history information associated with the first personal identification information.

### Effects of the Invention

According to the first aspect and the second aspect of the present technology, it is possible to improve convenience of use while maintaining security.

It should be noted that the effects of the present technology are not limited to the effects described herein, and may include any of the effects described in the present disclosure.

### BRIEF DESCRIPTION OF DRAWINGS

FIG. 1 is a diagram showing an example configuration of an information processing system.

FIG. 2 is a diagram showing an example configuration of a data center.

FIG. 3 is a diagram showing an example of a database.

FIG. 4 is a diagram showing an example configuration of a member store terminal device.

FIG. 5 is a diagram showing an example configuration of a mobile terminal device.

FIG. 6 is a diagram showing an example configuration of a mobile terminal device.

FIG. 7 is a flowchart for explaining a read process, a provisional registration request process, and a provisional registration process.

FIG. 8 is a flowchart for explaining a registration request process and a registration process.

FIG. 9 is a flowchart for explaining a medication history update request process.

FIG. 10 is a flowchart for explaining a medication history update process.

FIG. 11 is a flowchart for explaining a deletion request process and a deletion process.

FIG. 12 is a diagram showing an example of a database.

FIG. 13 is a flowchart for explaining a medication history update request process.

FIG. 14 is a flowchart for explaining a medication history update process.

FIG. 15 is a flowchart for explaining a deletion request process and a deletion process.

FIG. 16 is a diagram showing an example of a database.

FIG. 17 is a flowchart for explaining a read process, a provisional registration request process, and a provisional registration process.

FIG. 18 is a flowchart for explaining a notification reception process.

FIG. 19 is a flowchart for explaining a notification process.

FIG. 20 is a flowchart for explaining a deletion request process and a deletion process.

FIG. 21 is a diagram showing an example of a database.

FIG. 22 is a flowchart for explaining a medication history update request process.

FIG. 23 is a flowchart for explaining a medication history update process.

FIG. 24 is a flowchart for explaining a reissuance process.

FIG. 25 is a flowchart for explaining a determination process.

FIG. 26 is a flowchart for explaining a read process, a provisional registration request process, and a provisional registration process.

FIG. 27 is a flowchart for explaining a medication history update request process.

FIG. 28 is a flowchart for explaining a medication history update process.

FIG. 29 is a diagram showing an example configuration of a computer.

### MODES FOR CARRYING OUT THE INVENTION

The following is a description of embodiments to which the present technology is applied, with reference to the drawings.

### First Embodiment

<Example Configuration of an Information Processing System>

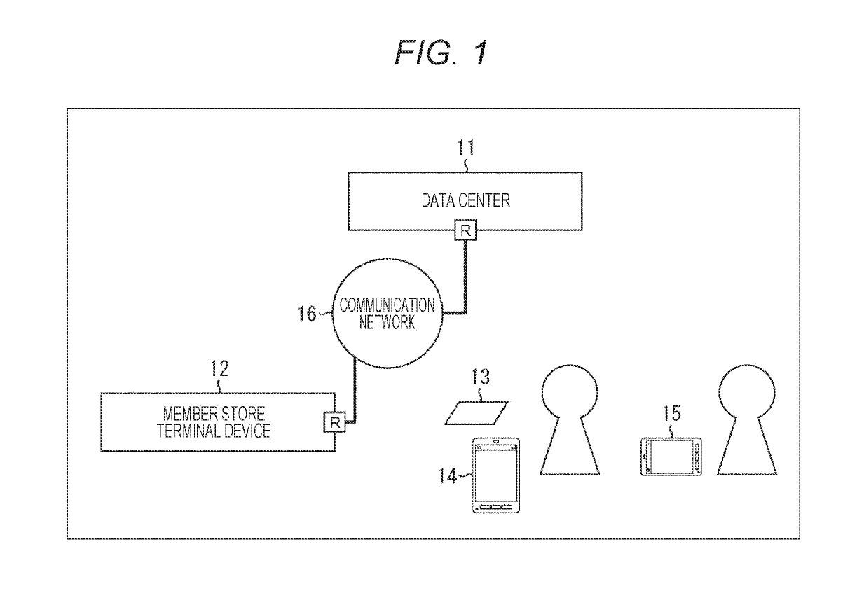

FIG. 1 is a diagram showing an example configuration of an embodiment of an information processing system to which the present technology is applied.

This information processing system includes a data center 11, a member store terminal device 12, an integrated circuit (IC) card 13 and a mobile terminal device 14 carried by a user, and a mobile terminal device 15 of a different user from the user. Also, the data center 11 and the member store terminal device 12 are connected to each other via a communication network 16 formed with a wired or wireless network, such as the Internet.

This information processing system can be used in providing users with various kinds of services. To specifically describe this aspect, an example case where a user uploads the medication history data of a computerized medication record to the data center 11, and views the medication history data when necessary will be described below. It should be noted that medication history data is uploaded by a service providing store that is used by the user or by the user only after authentication with the IC card 13, face-to-face authentication, or the like is performed as necessary.

Meanwhile, the user who owns the mobile terminal device 15 is the spouse, a member of the family, or the like of the user who owns the IC card 13. The user of the mobile terminal device 15 is allowed to view the medication history data of the user who owns the IC card 13. In the description below, the user who owns the mobile terminal device 15 is considered the spouse of the user who owns the IC card 13, and is also referred to simply as “the spouse”. “The user” means the user of the IC card 13.

The data center 11 manages medication history data supplied from the member store terminal device 12 and the mobile terminal device 14 for each user, and presents recorded medication history data in response to a request from the member store terminal device 12, the mobile terminal device 14, or the mobile terminal device 15.

It should be noted that although medication history data is described as an example of the data that is to be viewed and is managed by the data center 11 in this embodiment, the data to be viewed may be any data that can be managed for each user and be accessed by users and the like.

The member store terminal device 12 is installed in a service providing store that provides predetermined services. In this example, the member store terminal device 12 is installed in a pharmacy where the user purchases a prescribed medication, or in a hospital the user regularly visits. In the description below, the service providing store is a pharmacy.

The member store terminal device 12 is formed with a computer or the like, and performs various kinds of processing in accordance with input operations performed by a pharmacist or the like. Specifically, the member store terminal device 12 generates the medication history data of the user in accordance with input operations performed by a pharmacist or the like, records the medication history data, and transmits the medication history data to the data center 11 via the communication network 16 and causes the data center 11 to record the medication history data.

The member store terminal device 12 also reads the personal identification ID that is an ID unique to the user and the personal information from the IC card 13 of the user, and uses the personal identification ID and the personal information in authenticating the user. The member store terminal device 12 also transmits the information and the like necessary for accessing the medication history data being managed by the data center 11, to the mobile terminal device 14 or the mobile terminal device 15 through short-range communication. It should be noted that although the member store terminal device 12 installed for reading personal identification IDs in a service providing store is used in this embodiment, the member store terminal device 12 may be any device that can read personal identification IDs and personal information, and transmit/receive information to/from the data center 11, the mobile terminal device 14, and the mobile terminal device 15 via a communication network. For example, instead of the member store terminal device 12, a mobile terminal device may be used to authenticate users, or view or update medication history data, for example.

Here, the personal identification ID is one piece of the personal identification information with which the user can be uniquely identified. However, it is normally not possible (or it is normally difficult) for any other person having obtained only the personal identification ID to identify the user who can be identified with the personal identification ID.

It should be noted that a medium required for obtaining the personal identification ID is not limited to an IC card or the like directly on which the personal identification ID is recorded, but may be a unique medium that cannot be rewritten or replaced. For example, in a case where unique information is obtained as a personal identification ID from biological information, the medium for obtaining the personal identification ID is part of or all of the human body. Alternatively, a mobile telephone device or the like containing an IC chip equivalent to the IC card may be used. In such a case, the personal identification ID is read from the mobile telephone device or the like containing the IC chip.

The IC card 13 is the IC card to be used by the user to receive a service provided by the service providing store or the like having the member store terminal device 12 installed therein. This IC card 13 is issued to each user. The personal identification ID for authenticating the user who uses services, and the personal information including the name, the date of birth, the gender, and the like of the user are recorded on the IC card 13. It should be noted that the personal information recorded on the IC card 13 may also include the address, a telephone number, the insurance card number, and the like of the user.

The IC card 13 communicates with the member store terminal device 12, and transmits the recorded personal identification ID and personal information to the member store terminal device 12.

The mobile terminal device 14 is formed with a mobile telephone device or the like carried by the user, and communicates with the member store terminal device 12 and the data center 11 via a communication network (not shown) or the communication network 16, to exchange information as necessary. For example, the mobile terminal device 14 receives medication history data from the data center 11 and displays the medication history data, or transmits medication history data to the data center 11 and causes the data center 11 to update the medication history data.

The mobile terminal device 15 is formed with a mobile telephone device or the like carried by the spouse of the user, and communicates with the data center 11 via a communication network (not shown) or the communication network 16, to receive and display the medication history data of the user.

It should be noted that although only one member store terminal device 12 is shown in the information processing system in the example in FIG. 1, more than one member store terminal device 12 is included in an information processing system in practice.

<Example Configuration of the Data Center>

Next, the configurations of the data center 11, the member store terminal device 12, the mobile terminal device 14, and the mobile terminal device 15 shown in FIG. 1 are described.

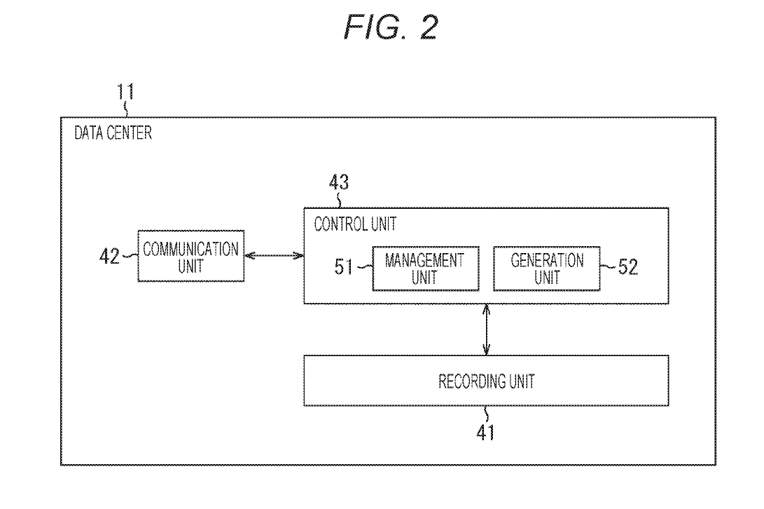

FIG. 2 is a diagram showing an example configuration of the data center 11. It should be noted that although the data center 11 is formed as one device in FIG. 2, the data center 11 may be formed with more than one device.

The data center 11 shown in FIG. 2 includes a recording unit 41, a communication unit 42, and a control unit 43.

The recording unit 41 is a database, for example, and stores the medication history data and various kinds of data of each user, such as a personal identification ID, a personally-set terminal code, an individual-based terminal ID, registration date information, and organization information. The recording unit 41 supplies recorded data to the control unit 43 as necessary.

Here, the individual-based terminal ID is the terminal identification information for uniquely identifying the mobile terminal device 14 or the mobile terminal device 15. The individual-based terminal ID is registered and associated with the personal identification ID in the data center 11. That is, the individual-based terminal ID is the information for uniquely determining which one of the mobile terminal device(s) registered and associated with the personal identification ID is the predetermined mobile terminal device 14 or mobile terminal device 15.

In view of this, with the use of the personal identification ID and the individual-based terminal ID, it is possible to uniquely determine which mobile terminal device is registered with which IC card 13 in the data center 11.

Meanwhile, the personally-set terminal code is the information for identifying the mobile terminal device 14 or the mobile terminal device 15, and has been set by the user or the spouse. The user and the spouse designate easy-to-remember information as the personally-set terminal code. Accordingly, looking at the personally-set terminal code, the user and the spouse can readily understand which mobile terminal device is indicated by the personally-set terminal code.

The personally-set terminal code is used when the right of access to the medication history data is invalidated, or when the use of services is stopped.

Meanwhile, the registration date information is the information indicating the time and date at and on which the processing was performed to register the mobile terminal device 14 or the mobile terminal device 15 as a terminal device allowed to access the medication history data of the user. The registration date information indicates time, day, month, and year, for example.

Further, the organization information is the information indicating the medical organization at which the processing was performed for the registration at the time and on the date indicated by the registration date information. That is, the organization information indicates a pharmacy or the like as the service providing store in which the member store terminal device 12 is installed. It should be noted that in the description below, the organization information is the pharmacy ID indicating the pharmacy as the service providing store in which the member store terminal device 12 is installed.

Meanwhile, the recording unit 41 stores information indicating the pharmacy name of the pharmacy as the service providing store registered beforehand, and the ID for uniquely identifying the service providing store. The information indicating the pharmacy name and the ID are associated with each other. In this embodiment, the pharmacy name and the pharmacy ID are associated with each other, and are recorded, for example. It should be noted that not only the pharmacy name but also information indicating the address showing the location of the pharmacy may be associated with the pharmacy ID and be recorded.

The communication unit 42 communicates with the member store terminal device 12, the mobile terminal device 14, and the mobile terminal device 15 via the communication network 16 or the like, to supply received information to the control unit 43, or transmit information supplied from the control unit 43.

The control unit 43 controls the entire operation of the data center 11. The control unit 43 includes a management unit 51 and a generation unit 52.

The management unit 51 performs processing for registration of the mobile terminal device 14 and the mobile terminal device 15 to enable viewing of the medication history data, and manages the data recorded in the recording unit 41. The generation unit 52 generates the individual-based terminal IDs to be recorded in the recording unit 41, and generates the registration date information.

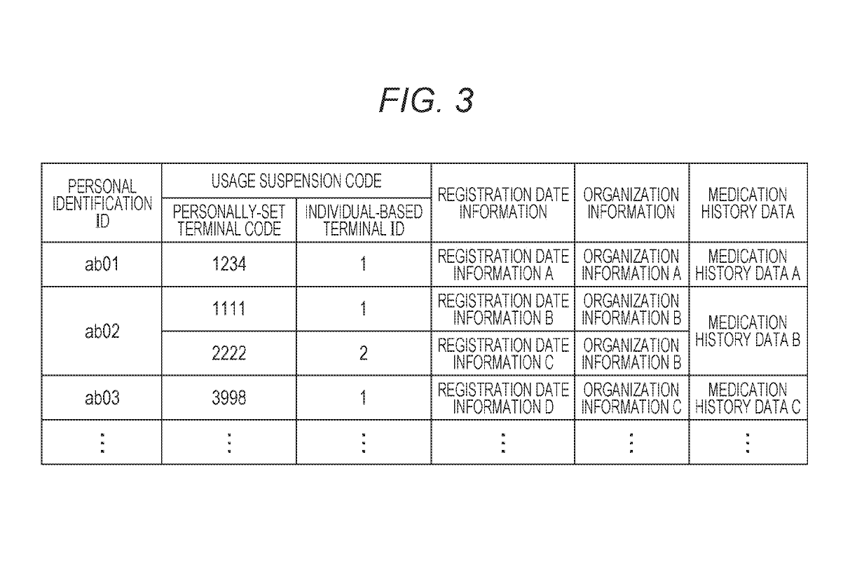

Examples of the personal identification IDs, the personally-set terminal codes, the individual-based terminal IDs, the registration date information, the organization information, and the medication history data recorded in the recording unit 41 are now described. For example, the personally-set terminal codes, the individual-based terminal IDs, the registration date information, the organization information, and the medication history data are associated with the personal identification IDs, and are recorded as a database, as shown in FIG. 3.

In FIG. 3, the personal identification IDs are information for uniquely identifying the users recorded on the IC cards 13. In the recording unit 41, the personally-set terminal codes, the individual-based terminal IDs, the registration date information, the organization information, and the medication history data are associated with the personal identification IDs.

For example, a personally-set terminal code “1234”, an individual-based terminal ID “1”, registration date information “registration date information A”, organization information “organization information A”, and medication history data “medication history data A” are associated with a personal identification ID “ab01”. Here, the medication history data associated with one personal identification ID is invariably one set of medication history data, but the numbers of the personally-set terminal codes, the individual-based terminal IDs, the pieces of registration date information, and the pieces of organization information associated with one personal identification ID are the same as the number of the registered mobile terminal devices 14 and 15.

For example, the personally-set terminal code “1111” of the mobile terminal device identified by the individual-based terminal ID “1”, and the personally-set terminal code “2222” of the mobile terminal device identified by an individual-based terminal ID “2” are associated with a personal identification ID “ab02”.

Accordingly, the same medication history data B can be accessed from two mobile terminal devices in this case. As the medication history data of a user can be accessed from the mobile terminal devices 14 and 15 in this manner, it is possible to improve convenience of use.

Also, in the example shown in FIG. 3, consecutive numbers in the order of registration are allotted as individual-based terminal IDs to the respective mobile terminal devices registered with the same personal identification ID. In this example, the serial numbers starting from “1” are allotted as the individual-based terminal IDs. Further, in the data center 11, a combination of an individual-based terminal ID and a personally-set terminal code associated with each other is a usage suspension code to be used to suspend the use of services in the mobile terminal device 14 or the mobile terminal device 15 of the user identified by the individual-based terminal ID. For example, a usage suspension code is information formed by adding an individual-based terminal ID to the end of the corresponding personally-set terminal code.

<Example Configuration of the Member Store Terminal Device>

Next, the configuration of the member store terminal device 12 is described.

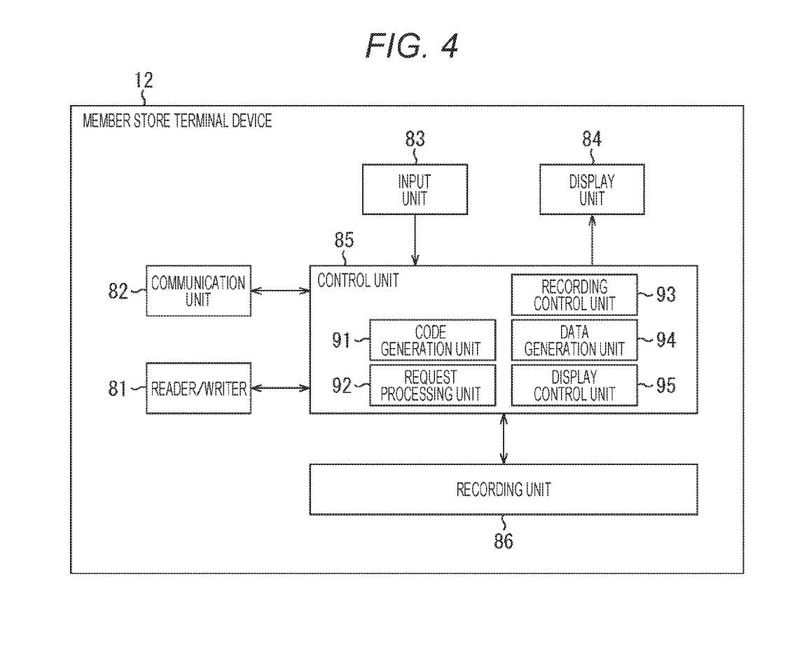

FIG. 4 is a diagram showing an example configuration of the member store terminal device 12. It should be noted that although the member store terminal device 12 is formed as one device in FIG. 4, the member store terminal device 12 may be formed with more than one device.

The member store terminal device 12 includes a reader/writer 81, a communication unit 82, an input unit 83, a display unit 84, a control unit 85, and a recording unit 86.

The reader/writer 81 performs non-contact communication with the IC card 13. The reader/writer 81 reads the personal identification ID and the personal information from the IC card 13 and supplies the personal identification ID and the personal information to the control unit 85, or supplies information supplied from the control unit 85 to the IC card 13 and causes the IC card 13 to record the information. The communication unit 82 communicates with devices such as the data center 11 via the communication network 16. The communication unit 82 receives transmitted information and supplies the information to the control unit 85, or transmits information supplied from the control unit 85.

The input unit 83 is formed with a mouse and the like, and supplies a signal corresponding to an operation performed by a pharmacist or the like to the control unit 85. The display unit 84 is formed with a liquid crystal display panel or the like, and displays an image or the like in accordance with data supplied from the control unit 85.

The control unit 85 controls operation of the entire member store terminal device 12. The control unit 85 includes a code generation unit 91, a request processing unit 92, a recording control unit 93, a data generation unit 94, and a display control unit 95.

The code generation unit 91 generates a QR code in accordance with the personal information and the like read from the IC card 13. Meanwhile, the request processing unit 92 performs processing to issue various kinds of requests to the data center 11, such as a request for provisional registration of the mobile terminal device 14 and the mobile terminal device 15.

The recording control unit 93 controls the reader/writer 81 and causes the reader/writer 81 to record various kinds of information on the IC card 13. The data generation unit 94 generates medication history data and the like in accordance with a signal supplied from the input unit 83 in accordance with an operation performed by a pharmacist or the like. The display control unit 95 controls display of various kinds of information and data on the display unit 84.

The recording unit 86 stores the medication history data of the user and various kinds of data such as the pharmacy ID, and supplies the data to the control unit 85 as necessary.

<Example Configuration of a Mobile Terminal Device>

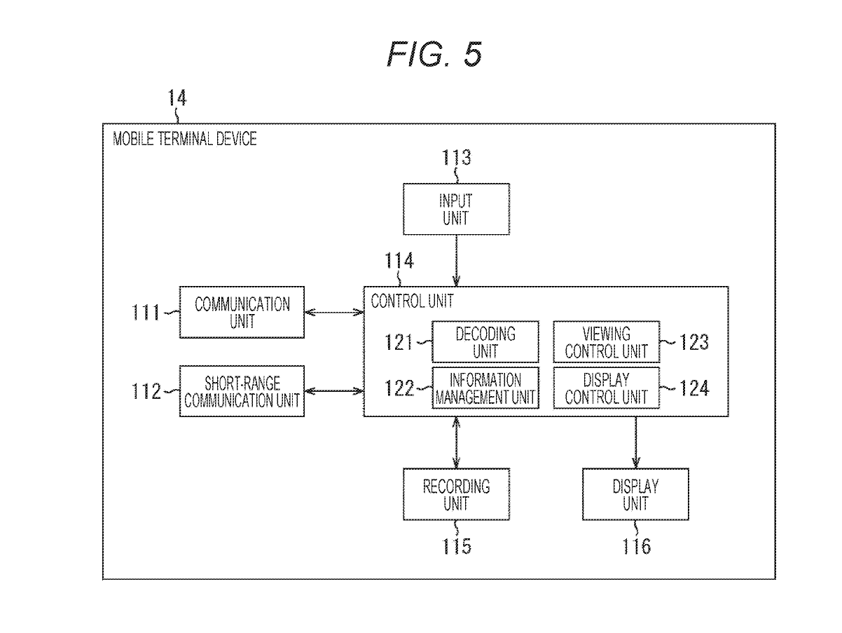

Further, FIG. 5 is a diagram showing an example configuration of the mobile terminal device 14.

The mobile terminal device 14 includes a communication unit 111, a short-range communication unit 112, an input unit 113, a control unit 114, a recording unit 115, and a display unit 116.

The communication unit 111 communicates with external devices such as the member store terminal device 12 and the data center 11. The communication unit 111 receives various kinds of data and supplies the data to the control unit 114, or transmits data supplied from the control unit 114.

The short-range communication unit 112 performs short-range communication with the member store terminal device 12, and supplies information received from the member store terminal device 12 to the control unit 114. The short-range communication unit 112 is formed with a camera, for example. The short-range communication unit 112 images a QR code displayed on the member store terminal device 12, and supplies the obtained image information to the control unit 114.

The input unit 113 is formed with an input button, a touch panel, a microphone, and the like, and supplies a signal corresponding to an input operation performed by the user to the control unit 114.

The control unit 114 controls operation of the entire mobile terminal device 14. The control unit 114 includes a decoding unit 121, an information management unit 122, a viewing control unit 123, and a display control unit 124.

The decoding unit 121 decodes the image information supplied from the short-range communication unit 112, and extracts the information written in the QR code. The information management unit 122 manages the various kinds of data recorded in the recording unit 115. Specifically, the information management unit 122 supplies data to the recording unit 115 and causes the recording unit 115 to record the data, or reads data recorded in the recording unit 115.

The viewing control unit 123 performs processing related to viewing of the medication history data recorded in the data center 11. The display control unit 124 controls display of an image or information on the display unit 116.

The recording unit 115 stores various kinds of data supplied from the control unit 114, and supplies the data to the control unit 114 as necessary. The display unit 116 is formed with a liquid crystal display panel or the like, and displays various images or information in accordance with data supplied from the control unit 114.

<Example Configuration of a Mobile Terminal Device>

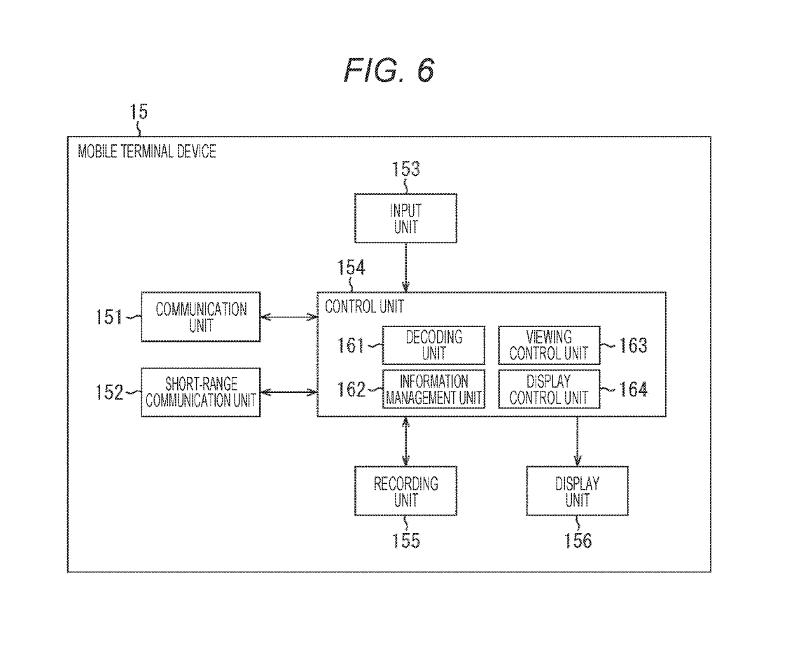

Further, FIG. 6 is a diagram showing an example configuration of the mobile terminal device 15.

The mobile terminal device 15 includes a communication unit 151, a short-range communication unit 152, an input unit 153, a control unit 154, a recording unit 155, and a display unit 156.

It should be noted that these components from the communication unit 151 to the display unit 156 are similar to the components from the communication unit 111 to the display unit 116 of the mobile terminal device 14 shown in FIG. 5, and therefore, explanation of them is not made herein. Also, the control unit 154 includes a decoding unit 161, an information management unit 162, a viewing control unit 163, and a display control unit 164. These components from the decoding unit 161 to the display control unit 164 are similar to the components from the decoding unit 121 to the display control unit 124 of the control unit 114, and therefore, explanation of them is not made herein.

<Provisional Registration>

Next, operation of the information processing system shown in FIG. 1 is described.

In the information processing system, the user and the spouse can view the medication history data recorded in the data center 11 through the mobile terminal device 14 or the mobile terminal device 15. To view the medication history data, the user and the spouse need to register beforehand, with the data center 11, the information related to the mobile terminal device 14 and the mobile terminal device 15 to be used for the viewing.

In this embodiment, the user or the spouse first performs provisional registration, to record the personal identification ID and the individual-based terminal ID into the mobile terminal device 14 or the mobile terminal device 15. The user or the spouse then transmits the personally-set terminal code to the data center 11, to complete definitive registration. By doing so, the user or the spouse is enabled to view the medication history data on the mobile terminal device 14 or the mobile terminal device 15.

In the example case described below, the user does not view the medication history data on the mobile terminal device 14, but the wife (spouse) of the user views the medication history data on the mobile terminal device 15 after obtaining permission from the user. In such a case, the provisional registration and the definitive registration described below are performed.

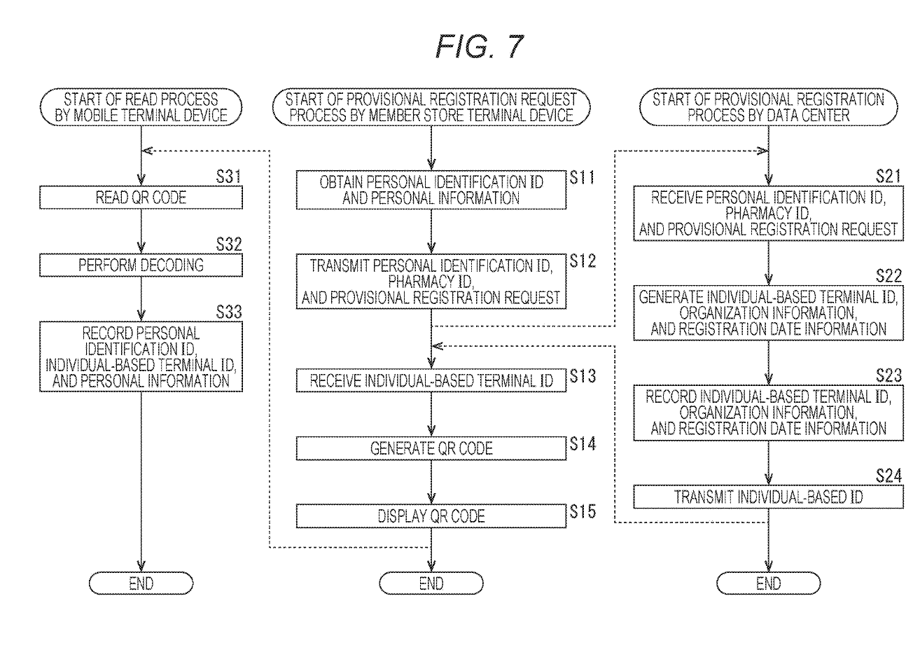

Referring first to the flowchart in FIG. 7, the read process to be performed by the mobile terminal device 15, the provisional registration request process to be performed by the member store terminal device 12, and the provisional registration process to be performed by the data center 11 at the time of provisional registration are described.

In a case where the mobile terminal device 15 carried by the spouse is to be provisionally registered, the user and the spouse visit the service providing store having the member store terminal device 12 installed therein, and tell a pharmacist or the like as a store clerk of the service providing store that they wish to newly register the mobile terminal device 15. Alternatively, the spouse may receive the IC card 13 from the user beforehand, and visit the pharmacy alone.

After the pharmacist or the like is informed of the request for registration, the pharmacist or the like asks for presentation of the IC card 13 carried by the user.

Then, as the user holds the IC card 13 over the reader/writer 81 of the member store terminal device 12, the reader/writer 81 of the member store terminal device 12 in step S11 performs non-contact communication with the IC card 13, to obtain the personal identification ID and the personal information from the IC card 13, and supply the personal identification ID and the personal information to the control unit 85. Also, the display control unit 95 supplies the personal identification ID and the personal information supplied from the reader/writer 81 to the display unit 84 as necessary, and causes the display unit 84 to display the personal identification ID and the personal information. Using the displayed personal information and the like, the pharmacist or the like confirms the user's identity in an appropriate manner.

In step S12, the communication unit 82 transmits the personal identification ID, the pharmacy ID, and a provisional registration request to the data center 11 via the communication network 16.

Specifically, the request processing unit 92 reads the pharmacy ID for identifying the pharmacy having the member store terminal device 12 installed therein from the recording unit 86, and generates a provisional registration request to request new provisional registration of the mobile terminal device 15 with respect to the user identified by the personal identification ID. This provisional registration request is to request registration so that the mobile terminal device 15 can access the recorded medication history data associated with the personal identification ID.

The request processing unit 92 supplies the communication unit 82 with the personal identification ID supplied from the reader/writer 81, the pharmacy ID read from the recording unit 86, and the provisional registration request, and instructs the communication unit 82 to perform transmission. The communication unit 82 then transmits the personal identification ID, the pharmacy ID, and the provisional registration request supplied from the request processing unit 92, to the data center 11.

In step S21, the communication unit 42 of the data center 11 receives the personal identification ID, the pharmacy ID, and the provisional registration request transmitted from the member store terminal device 12, and supplies the control unit 43 with the personal identification ID, the pharmacy ID, and the provisional registration request.

In step S22, the generation unit 52 generates the individual-based terminal ID, the organization information, and the registration date information for the received personal identification ID.

Specifically, the management unit 51 instructs the generation unit 52 to generate the individual-based terminal ID, the organization information, and the registration date information, in accordance with the received provisional registration request. The generation unit 52 generates the individual-based terminal ID in accordance with the instruction. It should be noted that, in the recording unit 41, the individual-based terminal ID differs from the other recorded individual-based terminal ID associated with the personal identification ID to register, and may be any kind of identification information that is unique to the personal identification ID.

The generation unit 52 also generates information indicating the current time and date as the registration date information in accordance with the instruction from the management unit 51, and sets the pharmacy ID received by the communication unit 42 as the organization information.

Such registration date information and organization information can be regarded as information related to the registration of the mobile terminal device 15. For example, the registration date information indicates the time and date at and on which the mobile terminal device 15 has been provisionally registered, and the pharmacy ID as the organization information indicates the pharmacy where the mobile terminal device 15 has been provisionally registered, or more specifically, the pharmacy where the request for the provisional registration of the mobile terminal device 15 has been accepted.

In step S23, the management unit 51 supplies the individual-based terminal ID, the organization information, and the registration date information to the recording unit 41, and causes the recording unit 41 to record the individual-based terminal ID, the organization information, and the registration date information. Specifically, the management unit 51 causes the recording unit 41 to associate and record the individual-based terminal ID, the organization information, and the registration date information with the same personal identification ID as the personal identification ID received in step S21 among the personal identification IDs recorded in the recording unit 41.

For example, in a case where the personal identification ID “ab02” is received, and the individual-based terminal ID “1” is generated in the example shown in FIG. 3, the individual-based terminal ID “1”, registration date information “registration date information B”, and organization information “organization information B” are newly associated with the personal identification ID “ab02” and are recorded. Accordingly, with the personal identification ID and the individual-based terminal ID, the combination of the IC card 13 and the mobile terminal device 15 can be uniquely identified. It should be noted that if the corresponding personal identification ID is not recorded in the recording unit 41, the personal identification ID is newly recorded, and the individual-based terminal ID, the organization information, and the registration date information are associated with the personal identification ID and are then recorded.

As the individual-based terminal ID, the organization information, and the registration date information are associated with the personal identification ID and are recorded in the above manner, the provisional registration of the mobile terminal device 15 is completed. When the provisional registration is completed, the management unit 51 supplies the generated individual-based terminal ID to the communication unit 42, and instructs the communication unit 42 to perform transmission.

In step S24, the communication unit 42 transmits the individual-based terminal ID supplied from the management unit 51 to the member store terminal device 12 via the communication network 16, and the provisional registration process then comes to an end. It should be noted that more specifically, the communication unit 42 transmits response information to the member store terminal device 12. The response information includes the individual-based terminal ID, and indicates that the mobile terminal device corresponding to the individual-based terminal ID has been provisionally registered as a viewing terminal device allowed to view the medication history data.

Meanwhile, in step S13, the communication unit 82 of the member store terminal device 12 receives the individual-based terminal ID transmitted from the data center 11, and supplies the individual-based terminal ID to the control unit 85.

In step S14, the code generation unit 91 generates a QR code in accordance with the individual-based terminal ID received in step S13 and the personal identification ID and the personal information read in step S11, and supplies the QR code to the display unit 84. The QR code generated by the code generation unit 91 contains information that is the personal identification ID, the individual-based terminal ID, and the personal information.

In step S15, the display unit 84 displays the QR code supplied from the code generation unit 91, and the provisional registration request process then comes to an end. Specifically, as the display unit 84 is made to display the QR code, the code generation unit 91 performs short-range communication with the mobile terminal device 15 through the QR code, and transmits the information contained in the QR code to the mobile terminal device 15. The process of displaying such a QR code on the display unit 84 can also be regarded as a process of displaying the personal identification ID, the individual-based terminal ID, and the personal information indicated by the QR code on the display unit 84.

It should be noted that although the QR code is generated in accordance with the personal identification ID, the individual-based terminal ID, and the personal information in the above described example, the QR code may be generated in accordance only with the personal identification ID and the individual-based terminal ID.

As the QR code is displayed on the display unit 84 in the above manner, the spouse of the user causes the mobile terminal device 15 to perform short-range communication with the member store terminal device 12 and to read the QR code.

Specifically, in step S31, the short-range communication unit 152 of the mobile terminal device 15 images the QR code displayed on the display unit 84 by using a camera function. The short-range communication unit 152 reads the QR code in this manner, and then supplies the QR code to the control unit 154. That is, QR code image information obtained as a result of the imaging is supplied to the control unit 154.

It should be noted that in the above described example, communication using the QR code is performed as the short-range communication for transmitting and receiving the personal identification ID, the individual-based terminal ID, and the personal information between the member store terminal device 12 and the mobile terminal device 15. However, the personal identification ID, the individual-based terminal ID, and the personal information may be transmitted and received by any other appropriate method, such as a communication method that does not involve the communication network 16 that is the Internet or the like, or a method of exchanging information via electronic mail or the like. For example, the member store terminal device 12 and the mobile terminal device 15 may perform infrared communication or near field communication (NFC) as the short-range communication, to transmit and receive the personal identification ID, the individual-based terminal ID, and the personal information.

In step S32, the decoding unit 161 decodes the QR code image information supplied from the short-range communication unit 152, to extract the personal identification ID, the individual-based terminal ID, and the personal information written in the QR code.

In step S33, the information management unit 162 supplies the personal identification ID, the individual-based terminal ID, and the personal information to the recording unit 155, and causes the recording unit 155 to record the personal identification ID, the individual-based terminal ID, and the personal information. The read process then comes to an end. As the personal identification ID and the individual-based terminal ID are recorded in the mobile terminal device 15 in this manner, the mobile terminal device 15 is enabled to access the data center 11 with the personal identification ID and the individual-based terminal ID. It should be noted that, if the personal identification ID and the individual-based terminal ID are recorded, the mobile terminal device 15 can access the data center 11. Therefore, the personal information is not necessarily recorded.

In the above manner, the data center 11 receives the personal identification ID from the member store terminal device 12, and, for the personal identification ID, generates and records the individual-based terminal ID with which the mobile terminal device 15 can be uniquely identified.

The individual-based terminal ID generated in the data center 11 is information that maintains uniqueness. As the individual-based terminal ID is generated in the data center 11 in this manner, the data center 11 can provide a service, though not holding any semi-personal information as the information for identifying the mobile terminal device 15, such as the SIM card ID or the telephone number of the mobile terminal device 15. As a result, security can be improved.

Furthermore, in the data center 11, the individual-based terminal IDs of the mobile terminal device 14 and the mobile terminal device 15 are associated with one personal identification ID and are recorded. Accordingly, the mobile terminal devices being used by the user or the like identified by a personal identification ID can be identified independently of each other on the side of the data center 11. That is, each mobile terminal device is distinguished on a user basis, and services can be provided. In this manner, the users' convenience can be improved.

Also, a user or the like can access the data center 11 through more than one mobile terminal device, and convenience of use can be improved. For example, the mobile terminal device 15 of the spouse of a user is registered so that the spouse can access the medication history data through the mobile terminal device 15.

<Definitive Registration>

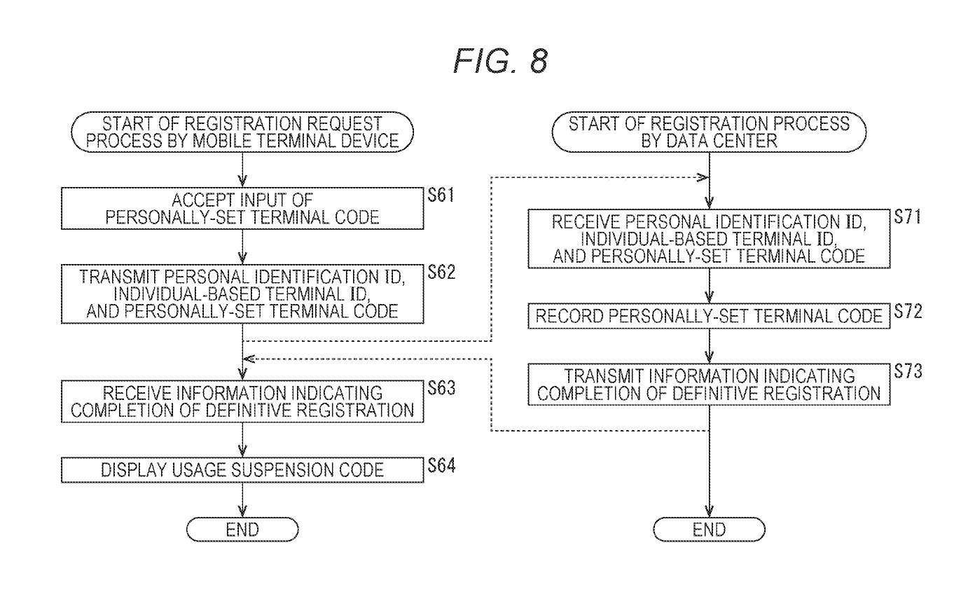

After the provisional registration is conducted in the above manner, the spouse accesses the data center 11 for definitive registration. Referring now to the flowchart in FIG. 8, the registration request process to be performed by the mobile terminal device 15, and the registration process to be performed by the data center 11 at the time of definitive registration are described.

In step S61, the viewing control unit 163 of the mobile terminal device 15 accepts an input of a personally-set terminal code from the user.

For example, when an application program that is designed for viewing medication history data and is recorded in the recording unit 115 is started for the first time, or when the web page or the like of the data center 11 is accessed for the first time, the viewing control unit 163 causes the display unit 156 to display a personally-set terminal code input screen.

A text message for prompting an input of a personally-set terminal code is displayed on this input screen. The spouse operates the input unit 153, to input a character string as a personally-set terminal code that is easy for the spouse to remember. The character string is formed with numbers, characters, symbols, or a combination of them. The information corresponding to the operation performed by the spouse, or the input personally-set terminal code, is then supplied from the input unit 153 to the control unit 154.

Also, in accordance with an instruction from the viewing control unit 163, the information management unit 162 reads the personal identification ID and the individual-based terminal ID from the recording unit 155. The viewing control unit 163 supplies the communication unit 151 with the read personal identification ID and individual-based terminal ID, and the personally-set terminal code supplied from the input unit 153.

In step S62, the communication unit 151 transmits the personal identification ID, the individual-based terminal ID, and the personally-set terminal code supplied from the viewing control unit 163, to the data center 11 via a communication network such as the communication network 16. More specifically, the communication unit 151 transmits a personally-set terminal code registration request containing the personal identification ID, the individual-based terminal ID, and the personally-set terminal code to the data center 11.

In step S71, the communication unit 42 of the data center 11 receives the personal identification ID, the individual-based terminal ID, and the personally-set terminal code transmitted from the mobile terminal device 15, and supplies the control unit 43 with the personal identification ID, the individual-based terminal ID, and the personally-set terminal code.

In step S72, the management unit 51 causes the recording unit 41 to record the personally-set terminal code, in accordance with the personal identification ID, the individual-based terminal ID, and the personally-set terminal code supplied from the communication unit 42. That is, in the recording unit 41, the personally-set terminal code is associated and recorded with the same personal identification ID as the received personal identification ID and the same individual-based terminal ID as the received individual-based terminal ID among the recorded personal identification IDs and individual-based terminal IDs.

As a result, in the recording unit 41, the individual-based terminal IDs and the personally-set terminal codes of the mobile terminal device 15 and the mobile terminal device 14 are associated with the personal identification ID and are recorded. The medication history data of the user identified by the personal identification ID is also associated with the personal identification ID and is recorded. As the personally-set terminal code is recorded in this manner, the definitive registration of the mobile terminal device 15 is completed.

When the definitive registration is completed, the management unit 51 supplies the communication unit 42 with information indicating the completion of the definitive registration, and instructs the communication unit 42 to transmit the information. The information indicating the completion of the definitive registration includes a usage suspension code, or the personally-set terminal code and the individual-based terminal ID.

In step S73, the communication unit 42 transmits the information that has been supplied from the management unit 51 and indicates the completion of the definitive registration to the mobile terminal device 15, and the registration process then comes to an end.

Meanwhile, in step S63, the communication unit 151 of the mobile terminal device 15 receives the information that has been transmitted from the data center 11 and indicates the completion of the definitive registration, and supplies the information to the control unit 154.

In step S64, the display control unit 164 supplies the display unit 156 with information such as the usage suspension code included in the information that has been supplied from the communication unit 151 and indicates the completion of the definitive registration. The display control unit 164 then causes the display unit 156 to display the information, and the registration request process comes to an end.

In this case, the usage suspension code is displayed, together with the message indicating the completion of the definitive registration, for example, on the display unit 156.

In this example, the registered mobile terminal device 15 belongs to the spouse of the user, and the spouse is not the user or the owner of the IC card 13. Therefore, the spouse notifies the user who owns the IC card 13 of the usage suspension code as necessary.

In the above described manner, the mobile terminal device 15 transmits the personally-set terminal code input by the spouse, the personal identification ID, and the individual-based terminal ID to the data center 11. The data center 11 associates and records the personally-set terminal code with the personal identification ID and the individual-based terminal ID.

As the personally-set terminal code of each mobile terminal device 15 is recorded in the data center 11 as described above, the rights to access the medication history data can be safely and easily managed with the use of the personally-set terminal code of each mobile terminal device 15 as appropriate. In this manner, security and convenience can be improved.

Also, in this information processing system, the same mobile terminal device 14 or the same mobile terminal device 15 may of course be registered with more than one IC card 13 so that the medication history data of more than one person can be viewed on the one mobile terminal device 14 or the one mobile terminal device 15.

It should be noted that although the mobile terminal device 15 of the spouse is registered in the above described case, the processes similar to those described above with reference to FIGS. 7 and 8 are performed when the mobile terminal device 14 is registered.

After the definitive registration is completed, the spouse can view the medication history data on the mobile terminal device 15. When a medication history data viewing instruction is issued, the communication unit 151 of the mobile terminal device 15 transmits the personal identification ID, the individual-based terminal ID, and a viewing request to the data center 11.

The data center 11 then receives the personal identification ID, the individual-based terminal ID, and the viewing request through the communication unit 42. In response to the viewing request, the management unit 51 reads the medication history data associated with the personal identification ID and the individual-based terminal ID. The communication unit 42 then transmits the read medication history data to the mobile terminal device 15. In this manner, access to the medication history data is managed with the personal identification ID and the individual-based terminal ID in the data center 11. That is, the personal identification ID and the individual-based terminal ID are used as an access key.

<Medication History Update and Registration Notification>

Meanwhile, to maintain security in the information processing system, the processing related to the registration of the user or the spouse, or the registration of a mobile terminal device, is performed, without any transmission or reception of personal information between the data center 11 and the member store terminal device 12.

When the user or the spouse is registered, the above described provisional registration request process is performed by the member store terminal device 12 using the personal identification ID read from the IC card 13. Therefore, while the personal identification ID is held in the member store terminal device 12, a malicious third party such as a pharmacist working at the pharmacy can intentionally misuse the personal identification ID of the user, and register the pharmacist's mobile terminal device. However, it is not easy for the user to notice the misuse.

In such a case, the malicious third party can view the medication history data of the user on his/her own mobile terminal device, without any permission from the user. To prevent this in the information processing system, the registration date information and the organization information are associated with the usage suspension code and are recorded in the data center 11, and, when a new registration is made, the user is notified of the details of the registration via the member store terminal device 12.

For example, after a new registration is made, the user may be notified of the new registration when the user visits the pharmacy to receive a service using the IC card 13, or to view the medication history or update the medication history. Alternatively, the user may be notified of the new registration when the new registration is made, or when the provisional registration or the definitive registration is completed, or the data center 11 receives a request for the provisional registration or the definitive registration. In the example case described below, when receiving a service using the IC card 13, the user is notified of the new registration for the first time.

In such a case, the user brings a new prescription to the pharmacy, for example, and receives a prescribed medication after handing the prescription to a pharmacist or the like. It should be noted that, in this case, the user is not necessarily accompanied by the spouse. The pharmacist or the like then creates medication history data in accordance with the user's prescription, and causes the data center 11 to record the medication history data. That is, the medication history data is updated. In this example, the user is notified of a new registration when the data center 11 is made to record the medication history data.

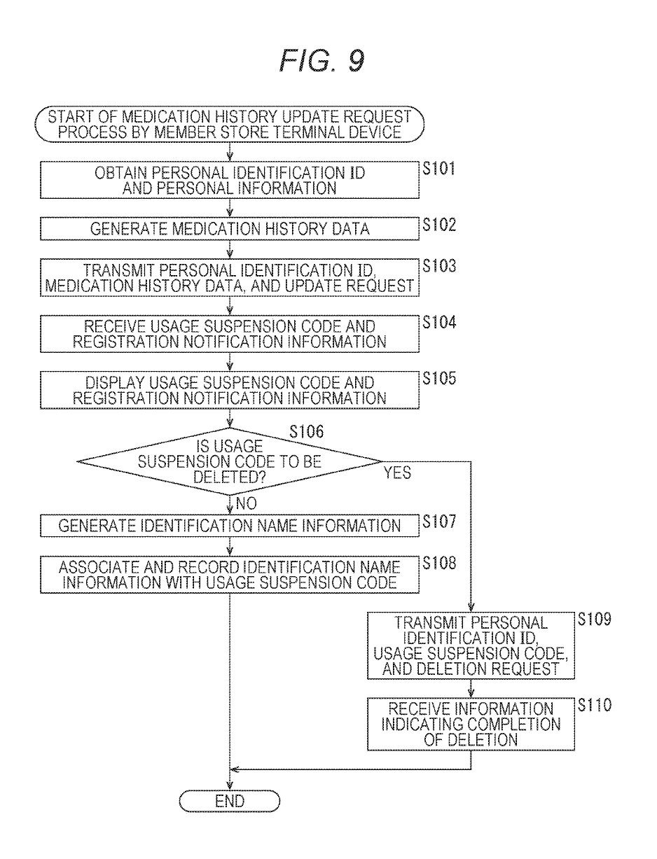

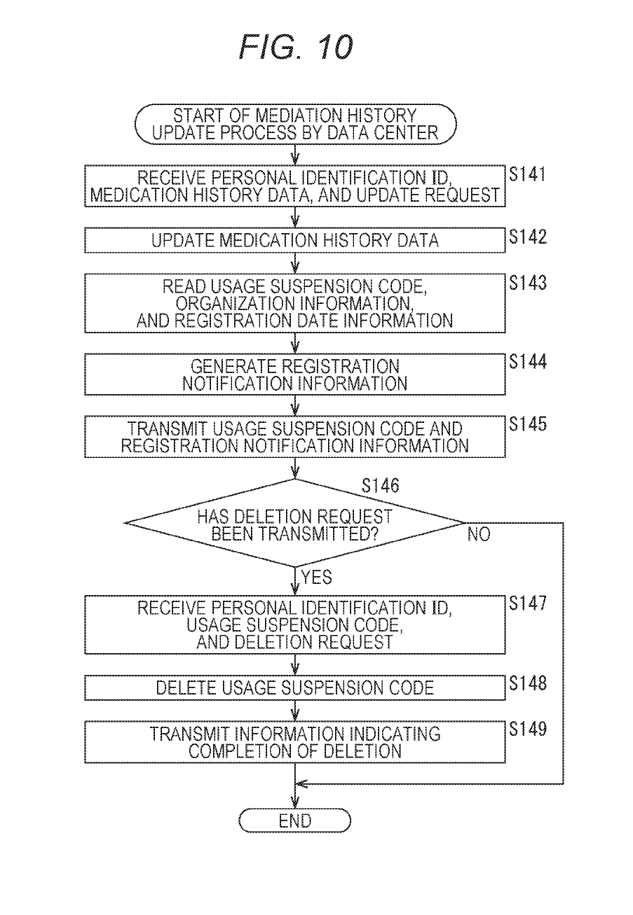

Referring now to the flowcharts in FIGS. 9 and 10, a medication history update request process and a medication history update process that are processes related to updating of medication history data and a registration notification to the user are described. Referring first to the flowchart in FIG. 9, the medication history update request process to be performed by the member store terminal device 12 is described.

As the user holds the IC card 13 over the reader/writer 81 of the member store terminal device 12, the reader/writer 81 in step S101 performs non-contact communication with the IC card 13, to obtain the personal identification ID and the personal information from the IC card 13, and supply the personal identification ID and the personal information to the control unit 85.

Also, the display control unit 95 supplies the personal identification ID and the personal information supplied from the reader/writer 81 to the display unit 84 as necessary, and causes the display unit 84 to display the personal identification ID and the personal information. Using the displayed personal information and the like, a pharmacist or the like confirms the user's identity in an appropriate manner.

After that, in step S102, the data generation unit 94 generates medication history data including the contents of the user's prescription, in accordance with a signal supplied from the input unit 83 in response to an operation performed by the pharmacist or the like. The request processing unit 92 then supplies the personal identification ID, the medication history data, and a medication history data update request to the communication unit 82.

In step S103, the communication unit 82 transmits the personal identification ID, the medication history data, and the medication history data update request supplied from the request processing unit 92, to the data center 11 via the communication network 16.

As a result, the medication history data of the user is updated in the data center 11. In addition, when the medication history data is updated, a notification about newly registered information and a usage suspension code are transmitted from the data center 11. Specifically, in regard to the mobile terminal device newly registered with the personal identification ID of the user, registration notification information to the effect that the mobile terminal device has been newly registered, and the usage suspension code of the mobile terminal device are transmitted.

Here, the registration notification information includes the time and data at and on which the new registration of the mobile terminal device has been accepted, or the registration date information indicating the time and data at and on which the provisional registration process has been performed, and the pharmacy name indicated by the organization information about the mobile terminal device. Specifically, the registration notification information is text information or the like indicating on what date and at which pharmacy the mobile terminal device identified by the corresponding usage suspension code has been provisionally registered. Alternatively, the registration notification information may include the usage suspension code.

In step S104, the communication unit 82 receives the usage suspension code and the registration notification information transmitted from the data center 11, and supplies the usage suspension code and the registration notification information to the control unit 85.

In step S105, the display control unit 95 supplies the display unit 84 with the usage suspension code and the registration notification information supplied from the communication unit 82, and causes the display unit 84 to display the usage suspension code and the registration notification information.

As the usage suspension code and the registration notification information are displayed on the display unit 84 in this manner, the pharmacist or the like shows the displayed usage suspension code and the registration notification information to the user, or tells the user about the usage suspension code and the contents of the registration notification information as appropriate, to prompt the user to check the registration. The user then determines whether he/she knows the newly registered person or mobile terminal device.

In doing so, the user can use not only the usage suspension code but also the information such as the date and location (pharmacy) on and at which the registration (provisional registration) has been conducted. Accordingly, it is possible for the user to determine more easily and accurately whether the new registration has been permitted by the user.

Since the personally-set terminal code included in the usage suspension code is normally information that is easy for the spouse and the user to remember, the user who was informed beforehand of the usage suspension code by the spouse can easily check the registration, using the usage suspension code. Also, the information related to the date and location of the registration is displayed together with the usage suspension code. Accordingly, the registration can be checked more easily and accurately.

As described above, when a new registration is made, the user is notified of the new registration. In this manner, a registration made by a malicious third party can be detected in an early stage, and security can be maintained. It should be noted that although the usage suspension code is displayed together with the registration notification information in the above described example, only the registration notification information may be displayed.

After the new registration is checked, the pharmacist or the like operates the input unit 83, to issue an instruction to perform an appropriate process. For example, in a case where the new registration indicated by the registration notification information is an unauthorized registration not permitted by the user, the pharmacist or the like issues an instruction to delete the information related to the registration.

In step S106, the request processing unit 92 determines whether to delete the usage suspension code sent with the registration notification information, in accordance with a signal supplied from the input unit 83 in response to the operation performed by the pharmacist or the like.

If the usage suspension code is determined not to be deleted in step S106, or if the new registration about which a notification has been sent with the registration notification information is a registration permitted by the user, the process moves on to step S107. In this case, the pharmacist or the like inputs identification name information that is information related to the mobile terminal device, for example. With the identification name information, the registered person, or the owner of the registered mobile terminal device, can be identified.

Here, the identification name information may be any information with which the user can identify the person (the mobile terminal device), such as the name of the owner of the registered mobile terminal device, the relationship to the user, or part or all of the telephone number. In this example, the pharmacist or the like inputs the name of the spouse of the user as the identification name information, for example, in accordance with an instruction from the user.

As a result, in step S107, the data generation unit 94 generates identification name information in accordance with a signal supplied from the input unit 83.

Also, the recording control unit 93 supplies the reader/writer 81 with the generated identification name information and the usage suspension code received in step S104, and instructs the reader/writer 81 to record the identification name information and the usage suspension code on the IC card 13.

In step S108, the reader/writer 81 transmits the identification name information and the usage suspension code supplied from the recording control unit 93, to the IC card 13 through non-contact communication. The identification name information and the usage suspension code are associated with each other, and are recorded. The medication history update request process then comes to an end. The IC card 13 associates the identification name information and the usage suspension code received from the reader/writer 81 with each other, and records the identification name information and the usage suspension code.

With this, the user is thereafter able to accurately recognize which mobile terminal devices are identified by the respective usage suspension codes, in accordance with the identification name information recorded on the IC card 13.

If the usage suspension code sent with the registration notification information is determined to be deleted in step S106, on the other hand, the communication unit 82 in step S109 transmits the personal identification ID, the usage suspension code, and a deletion request to the data center 11.

Specifically, in accordance with an operation performed by the pharmacist or the like, the request processing unit 92 generates the deletion request to request invalidation of the medication history data access right of the mobile terminal device identified by the usage suspension code.

The request processing unit 92 also supplies the communication unit 82 with the personal identification ID obtained in step S101, the usage suspension code received in step S104, and the generated deletion request, and instructs the communication unit 82 to transmit the personal identification ID, the usage suspension code, and the deletion request to the data center 11. The communication unit 82 then transmits the personal identification ID, the usage suspension code, and the deletion request supplied from the request processing unit 92, to the data center 11 via the communication network 16.

In the data center 11, the usage suspension code is deleted in accordance with the deletion request. Then, after the deletion is completed, information indicating the completion of the deletion is transmitted from the data center 11. For example, the information indicating the completion of the deletion also includes the deleted usage suspension code, or the usage suspension code of the mobile terminal device having its access right invalidated.

In step S110, the communication unit 82 receives the information that has been transmitted from the data center 11 and indicates the completion of the deletion, and supplies the information to the control unit 85. The display control unit 95 supplies the display unit 84 with the information supplied from the communication unit 82, and causes the display unit 84 to display the information. The medication history update request process then comes to an end. Alternatively, a viewing permission/prohibition flag related to the medication history data access right of the mobile terminal device identified by the usage suspension code may be associated with the usage suspension code and be recorded in the recording unit 41 of the data center 11 in advance, and the value of the viewing permission flag may be changed to invalidate the access right. For example, the viewing permission/prohibition flag is set to “1” when the access right of the mobile terminal device is valid, and the viewing permission/prohibition flag is set to “0” when the access right of the mobile terminal device is invalid. Only when the viewing permission/prohibition flag is “1”, is the mobile terminal device identified by the usage suspension code is allowed to access the medication history data.

As the usage suspension code and the like of the mobile terminal device stopped from using services are displayed on the display unit 84, the user and the like can recognize that the usage suspension code, which is the individual-based terminal ID and the personally-set terminal code, has been appropriately deleted.

In the above manner, the member store terminal device 12 receives and displays the usage suspension code and the registration notification information about the newly registered mobile terminal device when the medication history data is updated.

With this, the user can be made to check the new registration of the mobile terminal device without fail, and a function to protect against registration of a malicious third party can be achieved. As a result, security can be improved. Also, display of such registration notification information is expected to serve as a deterrent against unauthorized registration to be made by a pharmacist or the like, and enable the user to disclose information without worry.

Also, in a case where the mobile terminal device identified by the usage suspension code sent with the registration notification information has permission from the user, the usage suspension code and the identification name information are associated with each other and are recorded on the IC card 13, to further improve convenience of use. That is, the identification name information that is easy for the user to remember is associated with the usage suspension code and is recorded, so that the user can more accurately determine to whom the mobile terminal device identified by a usage suspension code belongs. Accordingly, when an operation to suspend the use of a mobile terminal device is performed, a desired mobile terminal device can be more easily and more accurately designated.

Referring now to the flowchart in FIG. 10, the medication history update process to be performed by the data center 11 is described. This medication history update process is started when an update request is transmitted from the member store terminal device 12.

In step S141, the communication unit 42 receives the personal identification ID, the medication history data, and the update request transmitted from the member store terminal device 12, and supplies the control unit 43 with the personal identification ID, the medication history data, and the update request. In step S141, the respective pieces of the information transmitted in step S103 in FIG. 9 are received.

In step S142, the management unit 51 updates the medication history data, in accordance with the update request supplied from the communication unit 42.

Specifically, the management unit 51 supplies the recording unit 41 with the medication history data supplied from the communication unit 42 as the portion of data to be updated, and controls the recording unit 41 so that the medication history data is added to the medication history data that is associated with the personal identification ID supplied from the communication unit 42 and is recorded in the recording unit 41. Under the control of the management unit 51, the recording unit 41 updates the medication history data by recording the medication history data supplied from the management unit 51.

In step S143, the management unit 51 selects a usage suspension code for which a registration notification has not yet been sent to the user, and reads the selected usage suspension code, and the organization information and the registration date information associated with the usage suspension code.

For example, the recording unit 41 records a flag associated with each usage suspension code. The flag indicates whether a registration notification has been sent. In accordance with the personal identification ID received in the procedure in step S141, the management unit 51 selects a usage suspension code associated with a flag having the value indicating that a registration notification has not been sent yet, from among the usage suspension codes associated with the personal identification ID. The management unit 51 then reads the usage suspension code, the organization information, and the registration date information. It should be noted that a record as to whether a registration notification has been sent may be stored for the one notification destination or each of the notification destinations, or may be recorded regardless of the notification destination(s).

It should be noted that in a case where there are no usage suspension codes for which any registration notification has not been sent to the user, the procedures that follow are not carried out, and the medication history update process comes to an end.

In step S144, the management unit 51 generates registration notification information in accordance with the read organization information and registration date information, and supplies the communication unit 42 with the registration notification information together with the usage suspension code.

For example, the management unit 51 further reads, from the recording unit 41, the information indicating the pharmacy name associated with the pharmacy ID as the organization information, and generates registration notification information that includes the registration date information and the pharmacy name.

In step S145, the communication unit 42 transmits the usage suspension code and the registration notification information supplied from the management unit 51, to the member store terminal device 12 via the communication network 16. As a result, the usage suspension code and the registration notification information are received in step S104 in FIG. 9.

In addition, after the registration notification information is transmitted, and the member store terminal device 12 is notified of the registration, the management unit 51 changes the value of the flag associated with the usage suspension code for which the notification has been transmitted, to the value indicating that the registration notification has been sent.

In step S146, the management unit 51 determines whether a deletion request has been transmitted.

If it is determined in step S146 that any deletion request has not been transmitted, the medication history update process comes to an end.

If it is determined in step S146 that a deletion request has been transmitted, on the other hand, the communication unit 42 in step S147 receives the personal identification ID, the usage suspension code, and the deletion request transmitted from the member store terminal device 12, and supplies the control unit 43 with the personal identification ID, the usage suspension code, and the deletion request. The personal identification ID, the usage suspension code, and the deletion request received in step S147 have been transmitted in step S109 in FIG. 9.

In step S148, the management unit 51 deletes the usage suspension code, in accordance with the personal identification ID, the usage suspension code, and the deletion request supplied from the communication unit 42.

Specifically, in accordance with the deletion request, the management unit 51 instructs the recording unit 41 to delete the individual-based terminal ID and the personally-set terminal code that constitute the received usage suspension code, among the individual-based terminal IDs and the personally-set terminal codes associated with the received personal identification ID. In accordance with the instruction from the management unit 51, the recording unit 41 deletes the recorded individual-based terminal ID and personally-set terminal code, or the usage suspension code.

As the individual-based terminal ID and the personally-set terminal code designated by the member store terminal device 12 are deleted in the above manner, the mobile terminal device identified by the individual-based terminal ID is prohibited from accessing the medication history data. That is, the medication history data access right of the mobile terminal device is invalidated.

After the usage suspension code is deleted, the management unit 51 supplies the communication unit 42 with information indicating the completion of the deletion. For example, the information indicating the completion of the deletion also includes the usage suspension code of the mobile terminal device that has been stopped from using services or has its access right invalidated.

In step S149, the communication unit 42 transmits the information that has been supplied from the management unit 51 and indicates the completion of the deletion, to the member store terminal device 12 via the communication network 16. The medication history update process then comes to an end.

In a case where the medication history data associated with the personal identification ID is updated, if there is a usage suspension code for which any registration notification has not been sent to the user, the data center 11 generates registration notification information with respect to the usage suspension code as described above, and sends a registration notification. When there is a new registration, the user is notified of the registration as described above, so that unauthorized viewing of the medication history data can be prevented, and security can be improved.

<Deletion of a Personally-Set Terminal Code and an Individual-Based Terminal ID>

Using the IC card 13, the user can also invalidate permission given to the registered mobile terminal device 14 or the registered mobile terminal device 15 to view the medication history data, or a medication history data access right given to the mobile terminal device 14 or the mobile terminal device 15. In such a case, the user brings the IC card 13 to the pharmacy, and asks for deletion of a desired individual-based terminal ID and the corresponding personally-set terminal code, or deletion of a desired usage suspension code.

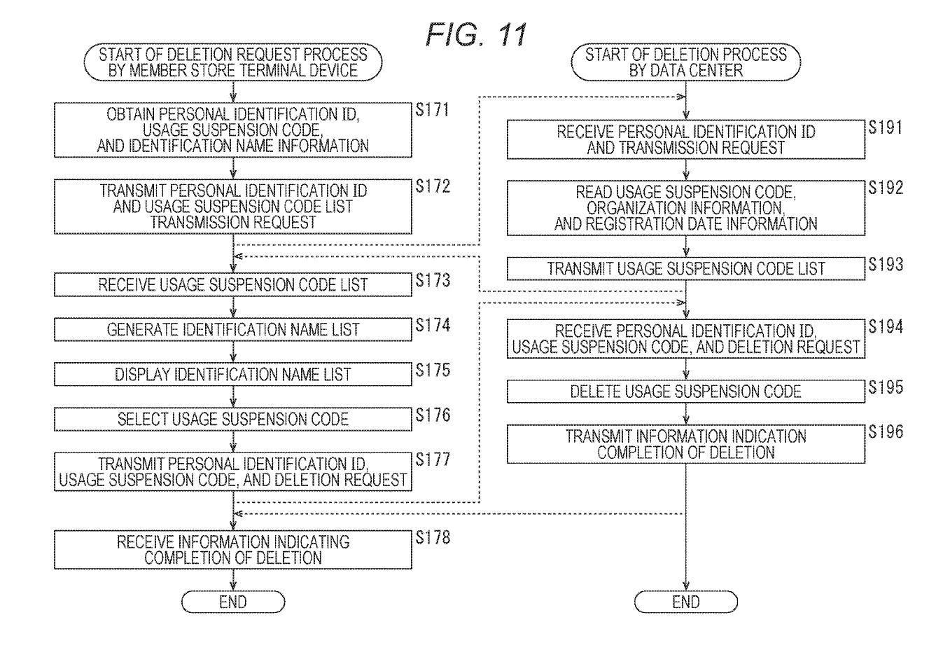

Referring now to FIG. 11, the deletion request process to be performed by the member store terminal device 12, and the deletion process to be performed by the data center 11 in such a case are described.

First, when the user holds the IC card 13 over the reader/writer 81 of the member store terminal device 12, the reader/writer 81 of the member store terminal device 12 in step S171 performs non-contact communication with the IC card 13, to obtain the personal identification ID, the usage suspension code, and the identification name information from the IC card 13, and supply the personal identification ID, the usage suspension code, and the identification name information to the control unit 85. It should be noted that the usage suspension code and the identification name information are associated with each other when obtained.

The request processing unit 92 generates a transmission request to request transmission of a usage suspension code list, and supplies the personal identification ID and the transmission request to the communication unit 82.

In step S172, the communication unit 82 transmits the personal identification ID and the usage suspension code list transmission request supplied from the request processing unit 92, to the data center 11 via the communication network 16.

As a result, in step S191, the communication unit 42 of the data center 11 receives the personal identification ID and the transmission request transmitted from the member store terminal device 12, and supplies the personal identification ID and the transmission request to the control unit 43.

In step S192, in accordance with the transmission request, the management unit 51 reads, from the recording unit 41, the usage suspension code, the organization information, and the registration date information associated and recorded with the personal identification ID supplied from the communication unit 42.

The management unit 51 then generates a usage suspension code list in accordance with the read organization information, organization information, and registration date information, and supplies the usage suspension code list to the communication unit 42. This usage suspension code list contains usage suspension codes, the organization names identified by organization information, and registration date information. For example, when the organization information is a pharmacy ID, the management unit 51 reads, from the recording unit 41, a pharmacy name as the organization name identified by the organization information, and generates a usage suspension code list containing the read pharmacy name.

In step S193, the communication unit 42 transmits the usage suspension code list supplied from the management unit 51, to the member store terminal device 12 via the communication network 16.

As a result, in step S173, the communication unit 82 of the member store terminal device 12 receives the usage suspension code list transmitted from the data center 11, and supplies the usage suspension code list to the control unit 85.

In step S174, the control unit 85 generates an identification name list from the identification name information obtained in step S171 and the usage suspension code list received in step S173.

For example, the identification name list is information that shows, in the form of a list, the organization names, the registration date information, and the identification name information associated with usage suspension codes. That is, the identification name information that is associated with the usage suspension code and has been obtained in step S171 is further associated with the organization name and the registration date information associated with the usage suspension code, and a list showing the organization names, the registration date information, and the identification name information about the respective usage suspension codes is generated as the identification name list.

In step S175, the display control unit 95 supplies the identification name list to the display unit 84, and causes the display unit 84 to display the identification name list. As a result, a list of the organization names, the registration date information, and the identification name information associated with the respective usage suspension codes (the identification name list) is displayed on the display unit 84. This identification name list does not show the usage suspension codes. However, the identification name list may show the usage suspension codes.

As the identification name list is displayed in the above manner, the user designates a desired piece of identification name information in the identification name list, using the identification name information, the registration date information, and the organization names as clues. By designating identification name information in this manner, the user selects a desired usage suspension code.

In step S176, the request processing unit 92 selects a usage suspension code in accordance with a signal supplied from the input unit 83 in response to the operation performed by the user or a pharmacist. That is, the request processing unit 92 selects the usage suspension code associated with the identification name information designated by the user (or a pharmacist), and sets the selected usage suspension code as the usage suspension code to be deleted.

The request processing unit 92 generates a request for deletion of the selected usage suspension code, or the personally-set terminal code and the individual-based terminal ID, and supplies the personal identification ID, the usage suspension code, and the deletion request to the communication unit 82. This deletion request is to request invalidation of the medication history data access right of the mobile terminal device identified by the usage suspension code or the individual-based terminal ID.

In step S177, the communication unit 82 transmits the personal identification ID, the usage suspension code, and the deletion request supplied from the request processing unit 92, to the data center 11 via the communication network 16.

As a result, in step S194, the communication unit 42 of the data center 11 receives the personal identification ID, the usage suspension code, and the deletion request transmitted from the member store terminal device 12, and supplies the personal identification ID, the usage suspension code, and the deletion request to the control unit 43.

After the deletion request is received, the procedures in steps S195 and S196 are carried out, and the deletion process then comes to an end. However, these procedures are similar to the procedures in steps S148 and S149 in FIG. 10, and therefore, explanation of them is not repeated herein.

After the usage suspension code designated by the user or the individual-based terminal ID and the personally-set terminal code are deleted, the mobile terminal device identified by the deleted individual-based terminal ID is prohibited from accessing the medication history data. That is, the right to access the medication history data is invalidated.

Also, after the information indicating the completion of the deletion is transmitted, the communication unit 82 of the member store terminal device 12 in step S178 receives the information that has been transmitted from the data center 11 and indicates the completion of the deletion, and supplies the information to the control unit 85. The display control unit 95 supplies the display unit 84 with the information supplied from the communication unit 82, and causes the display unit 84 to display the information. The deletion request process then comes to an end.

In the above manner, the member store terminal device 12 generates and displays an identification name list, causes the user to select a usage suspension code, and transmits the usage suspension code to the data center 11. The data center 11 then deletes the usage suspension code received from the member store terminal device 12.

As the identification name list is displayed to prompt the user to select a usage suspension code as described above, the user can easily and accurately select a usage suspension code in accordance with registration date information, organization name, and identification name information the user has input. Thus, convenience of use can be improved.

Particularly, in this case, the user does not need to remember a usage suspension code not containing any personal information. Instead, the user can select a usage suspension code in accordance with information that has been input by the user and is easy for the user to remember.

It should be noted that, in the above described example, the member store terminal device 12 receives a usage suspension code list containing registration date information and organization names from the data center 11, generates an identification name information list, and causes the user to select the identification name information associated with a usage suspension code from the identification name information list. However, the member store terminal device 12 may display a list of usage suspension codes and identification name information read from IC cards 13, and the usage suspension code to be deleted may be selected from the list. In such a case, the member store terminal device 12 does not need to receive a usage suspension code list from the data center 11.

### First Modification of the First Embodiment

<Recording of Identification Name Information>

It should be noted that, in the above described embodiment, identification name information that has been designated (input) by the user is associated with a usage suspension code and is recorded on the IC card 13. However, the identification name information may also be recorded in the data center 11.

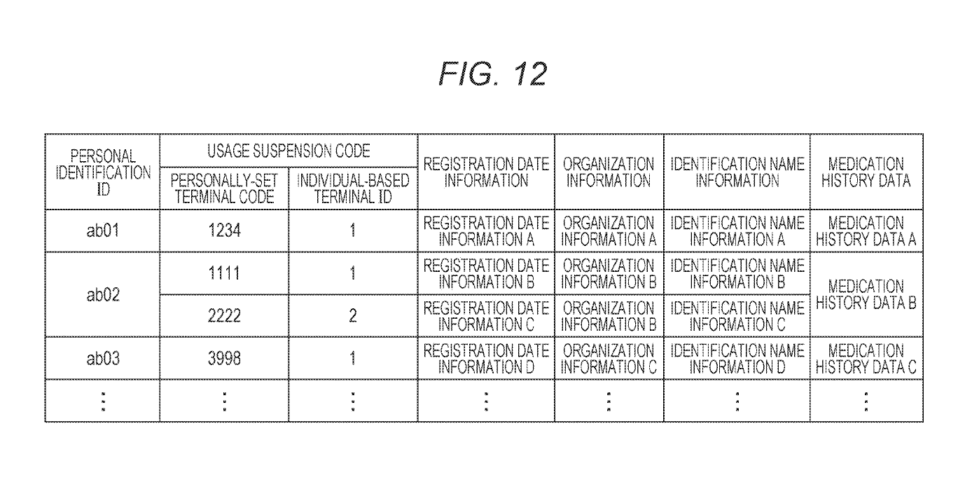

In such a case, personally-set terminal codes, individual-based terminal IDs, registration date information, organization information, identification name information, and medication history data are associated with personal identification IDs as shown in FIG. 12, for example, and are recorded in the recording unit 41 of the data center 11.

It should be noted that one or more individual-based terminal IDs are associated with each personal identification ID. Also, a personally-set terminal code, registration date information, organization information, and identification name information are associated with each of the individual-based terminal IDs associated with a personal identification ID.

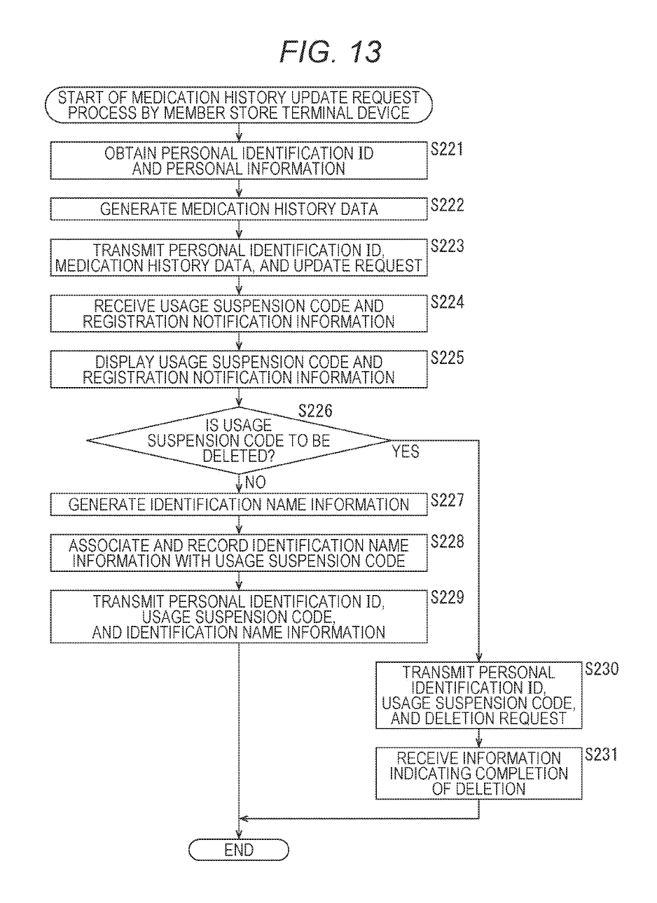

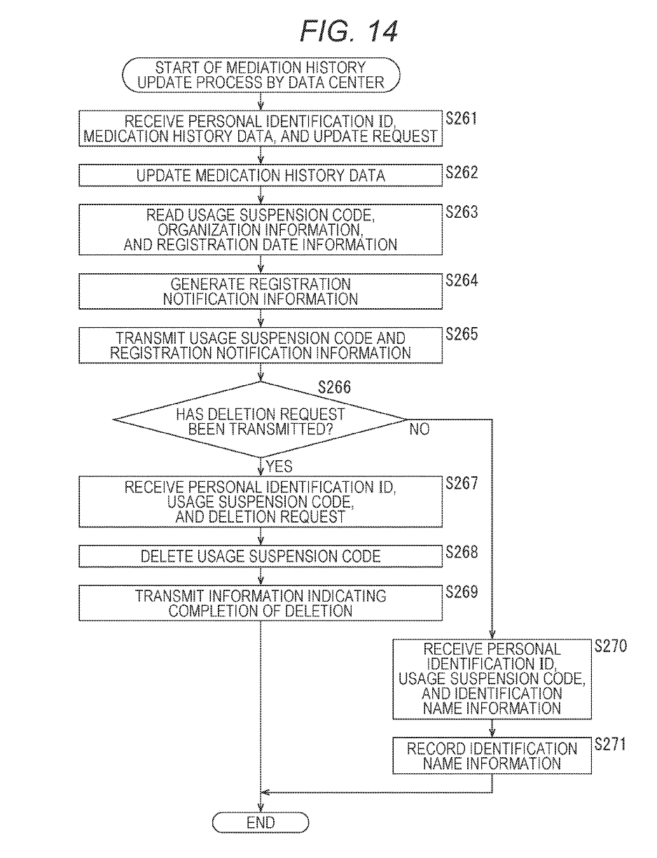

In a case where the identification name information is also recorded in the data center 11 in this manner, the processes shown in FIGS. 13 and 14 are performed as the processes equivalent to the medication history update request process shown in FIG. 9 and the medication history update process shown in FIG. 10.

Referring first to the flowchart in FIG. 13, the medication history update request process to be performed by the member store terminal device 12 is described. It should be noted that the procedures in steps S221 through S228 are similar to the procedures in steps S101 through S108 in FIG. 9, and therefore, explanation of them is not repeated herein.

In step S228, the usage suspension code and the identification name information are associated with each other and are recorded on the IC card 13 of the user. The request processing unit 92 then supplies the personal identification ID, the usage suspension code, and the identification name information to the communication unit 82.

In step S229, the communication unit 82 transmits the personal identification ID, the usage suspension code, and the identification name information supplied from the request processing unit 92, to the data center 11 via the communication network 16, and requests recording of the identification name information. The medication history update request process then comes to an end.

If the usage suspension code is determined to be deleted in step S226, on the other hand, the procedures in steps S230 and S231 are carried out, and the medication history update request process then comes to an end. However, these procedures are similar to the procedures in steps S109 and S110 in FIG. 9, and therefore, explanation of them is not repeated herein.

After the usage suspension code and the identification name information are recorded on the IC card 13 in the above manner, the member store terminal device 12 transmits the usage suspension code, the identification name information, and the personal identification ID to the data center 11, and causes the data center 11 to record the identification name information.

As the identification name information is also recorded in the data center 11 as described above, it is easy to determine which mobile terminal devices are identified by the respective usage suspension codes, and thus, convenience of use can be improved.

Referring now to the flowchart in FIG. 14, the medication history update process to be performed by the data center 11 is described. It should be noted that the procedures in steps S261 through S269 are similar to the procedures in steps S141 through S149 in FIG. 10, and therefore, explanation of them is not repeated herein.

In addition, if any deletion request has not been transmitted in step S266, or in a case where the personal identification ID, the usage suspension code, and the identification name information are transmitted by the procedure in step S229 in FIG. 13, the procedure in step S270 is carried out.

In step S270, the communication unit 42 receives the personal identification ID, the usage suspension code, and the identification name information transmitted from the member store terminal device 12, and supplies the control unit 43 with the personal identification ID, the usage suspension code, and the identification name information.

In step S271, in response to a request from the member store terminal device 12, the management unit 51 supplies the recording unit 41 with the identification name information supplied from the communication unit 42, and causes the recording unit 41 to record the identification name information.

Specifically, the management unit 51 controls the recording unit 41 so that the identification name information is associated and recorded with the usage suspension code identified by the personal identification ID and the usage suspension code supplied from the communication unit 42 among the usage suspension codes recorded in the recording unit 41. Under the control of the management unit 51, the recording unit 41 associates and records the identification name information with the usage suspension code designated by the management unit 51. After the identification name information is recorded, the medication history update process comes to an end.

In the above manner, the data center 11 associates identification name information received from the member store terminal device 12 with a personal identification ID and a usage suspension code, and records the identification name information. Accordingly, it becomes easier for the user to determine which mobile terminal devices are identified by the respective usage suspension codes, and convenience of use can be improved.

<Deletion of a Personally-Set Terminal Code and an Individual-Based Terminal ID>

Also, after identification name information is recorded in the data center 11, for example, the user can cause the pharmacy to delete a desired individual-based terminal ID (usage suspension code), and invalidate the medication history data access right of the mobile terminal device identified by the individual-based terminal ID.

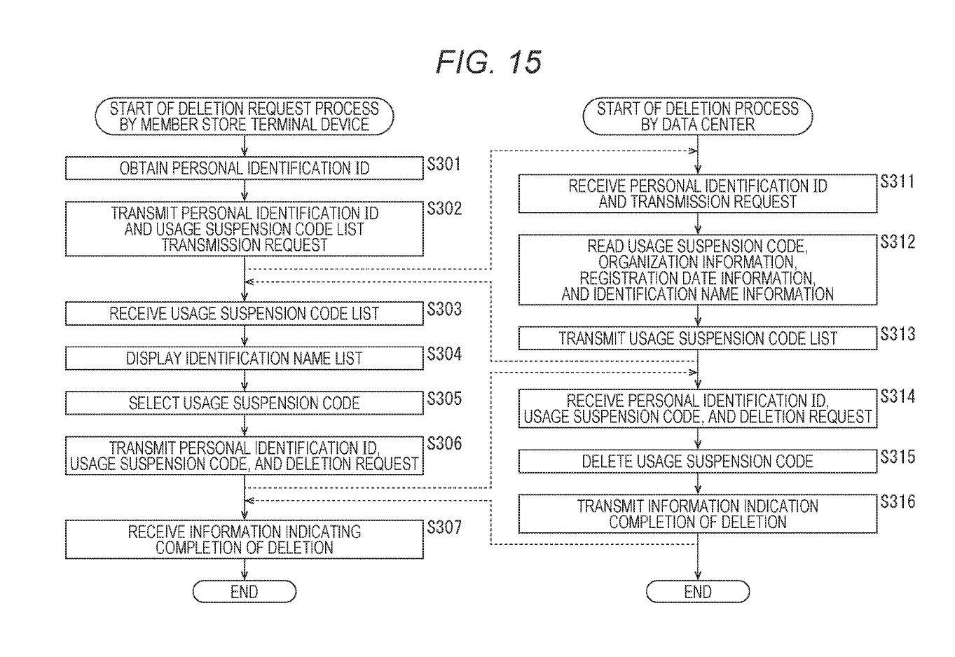

Referring now to the flowchart in FIG. 15, a deletion request process to be performed by the member store terminal device 12, and a deletion process to be performed by the data center 11 are described.

First, the user brings the IC card 13 to the pharmacy, and asks a pharmacist or the like for deletion of a desired individual-based terminal ID and the corresponding personally-set terminal code. The user then holds the IC card 13 over the member store terminal device 12.

As a result, in step S301, the reader/writer 81 of the member store terminal device 12 performs non-contact communication with the IC card 13, to obtain the personal identification ID from the IC card 13, and supply the personal identification ID to the control unit 85. At this point, the personal information is also read as necessary, and the user's identify is confirmed.

The request processing unit 92 generates a transmission request to request transmission of a usage suspension code list, and supplies the personal identification ID and the transmission request to the communication unit 82.

In step S302, the communication unit 82 transmits the personal identification ID and the usage suspension code list transmission request supplied from the request processing unit 92, to the data center 11 via the communication network 16.

As a result, in step S311, the communication unit 42 of the data center 11 receives the personal identification ID and the transmission request transmitted from the member store terminal device 12, and supplies the personal identification ID and the transmission request to the control unit 43.

In step S312, in accordance with the transmission request, the management unit 51 reads, from the recording unit 41, the usage suspension code, the organization information, the registration date information, and the identification name information associated and recorded with the personal identification ID supplied from the communication unit 42.

The management unit 51 then generates a usage suspension code list in accordance with the read organization information, organization information, registration date information, and identification name information, and supplies the usage suspension code list to the communication unit 42. This usage suspension code list contains usage suspension codes, the organization names identified by organization information, registration date information, and identification name information.

In step S313, the communication unit 42 transmits the usage suspension code list supplied from the management unit 51, to the member store terminal device 12 via the communication network 16.

As a result, in step S303, the communication unit 82 of the member store terminal device 12 receives the usage suspension code list transmitted from the data center 11, and supplies the usage suspension code list to the control unit 85.

In step S304, the display control unit 95 supplies the display unit 84 with an identification name list formed by eliminating the usage suspension codes from the usage suspension code list supplied from the communication unit 82. The display control unit 95 then causes the display unit 84 to display the identification name list.

Accordingly, the identification name list displayed on the display unit 84 shows a list of the organization names, the registration date information, and the identification name information associated with the usage suspension codes. It should be noted that identification name list may also show the usage suspension codes. That is, the usage suspension code list may be displayed as it is.

As the identification name list is displayed, the user designates desired identification name information in the identification name list. After identification name information is selected by the user, the procedures in steps S305 through S307 are carried out, and the deletion request process then comes to an end. However, these procedures are similar to the procedures in steps S176 through S178 in FIG. 11, and therefore, explanation of them is not repeated herein.

Also, when a usage suspension code is selected by the member store terminal device 12, and the personal identification ID, the usage suspension code, and a deletion request are transmitted, the procedures in steps S314 through S316 are carried out in the data center 11, and the deletion process then comes to an end. It should be noted that the procedures in steps S314 through S316 are similar to the procedures in steps S194 through S196 in FIG. 11, and therefore, explanation of them is not repeated herein.

In the above manner, the member store terminal device 12 transmits a usage suspension code selected by the user to the data center 11. The data center 11 then deletes the usage suspension code received from the member store terminal device 12.

As the identification name list is displayed to prompt the user to select a usage suspension code in the above manner, the user can easily and accurately select a usage suspension code, and thus, convenience of use can be improved.

### Second Embodiment

<Recording of Identity Information>

It should be noted that, in the above described example, a notification of a new registration is sent to the user via a pharmacy or the member store terminal device 12, because the user might not use the mobile terminal device 14. However, in a case where the user uses the mobile terminal device 14, a registration notification may be sent directly to the mobile terminal device 14 carried by the user.

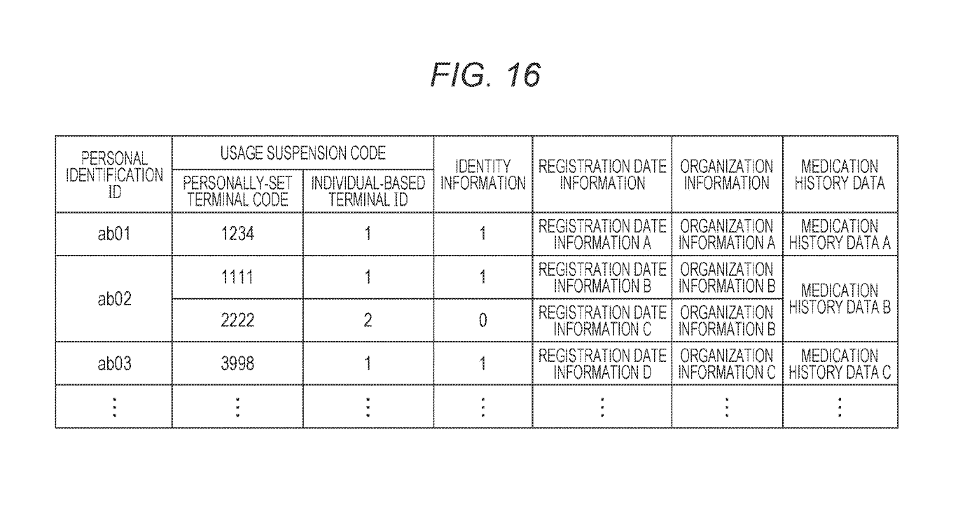

In such a case, personally-set terminal codes, individual-based terminal IDs, identity information, registration date information, organization information, and medication history data are associated with personal identification IDs as shown in FIG. 16, for example, and are recorded in the recording unit 41 of the data center 11.

It should be noted that one or more individual-based terminal IDs are associated with each personal identification ID. Also, a personally-set terminal code, identity information, registration date information, and organization information are associated with each of the individual-based terminal IDs associated with a personal identification ID.

Here, identity information is information indicating whether the mobile terminal device identified by the individual-based terminal ID associated with the identity information belongs to the user. In other words, identity information indicates whether the mobile terminal device identified by an individual-based terminal ID is a mobile terminal device to which a notification of a new registration and the like should be sent. For example, in a case where the medication history information about a child is managed by a confirming person such as a parent, a mobile terminal device of the confirming person, instead of a mobile terminal device of the user, may be registered as a mobile terminal device to which a notification of a new registration and the like should be sent.

Specifically, in a case where a mobile terminal device belongs to the user or the confirming person, the identity information is set to “1”. In a case where a mobile terminal device does not belong to the user and the confirming person, the identity information is set to “0”. It should be noted that in a case where more than one mobile terminal device 14 is registered with one personal identification ID, the identity information for only one mobile terminal device 14 may be set to “1”, or the identity information for more than one mobile terminal device 14 may be set to “1”.

In a case where identity information is also recorded in the data center 11 as described above, the mobile terminal device 15 owned by the spouse is newly registered in the data center 11 so that the medication history data can be viewed on the mobile terminal device 15. The processes to be performed in such a case are described below. It should be noted that, in this case, the mobile terminal device 14 owned by the user has already been associated with the personal identification ID and been registered as a terminal device to which a notification of a new registration and the like should be sent.

In a case where the mobile terminal device 15 carried by the spouse is to be provisionally registered, the user and the spouse visit the service providing store having the member store terminal device 12 installed therein, and tell a pharmacist or the like as a store clerk of the service providing store that they wish to newly register the mobile terminal device 15. The pharmacist or the like then asks for presentation of the IC card 13 carried by the user. Then, as the user holds the IC card 13 over the reader/writer 81 of the member store terminal device 12, provisional-registration-related processes equivalent to the processes described above with reference to FIG. 7 are performed.

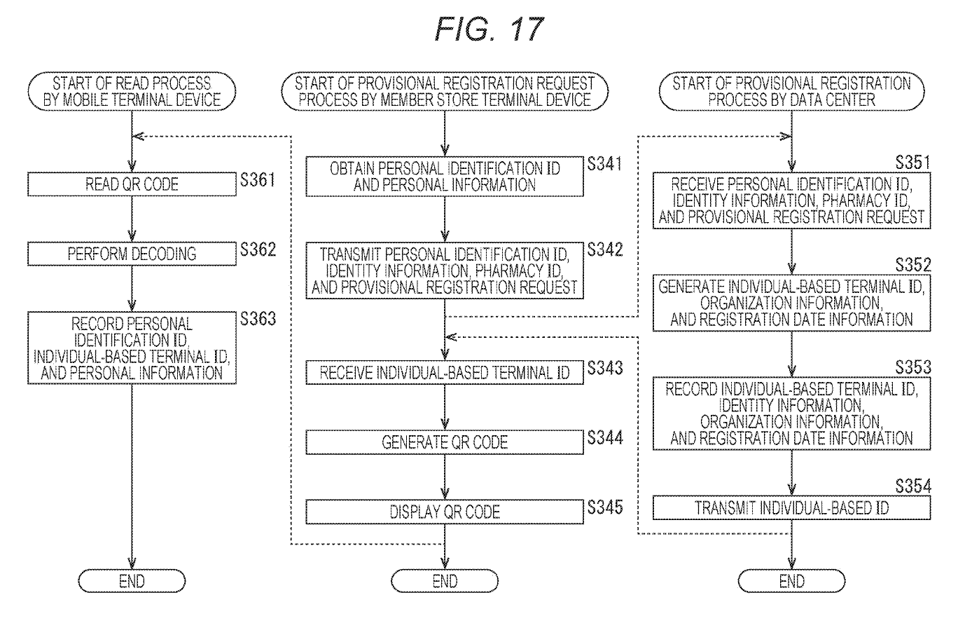

Referring now to the flowchart in FIG. 17, the read process to be performed by the mobile terminal device 15, the provisional registration request process to be performed by the member store terminal device 12, and the provisional registration process to be performed by the data center 11 at the time of provisional registration are described.

In step S341, the reader/writer 81 of the member store terminal device 12 performs non-contact communication with the IC card 13, to obtain the personal identification ID and personal information from the IC card 13, and supply the personal identification ID and the personal information to the control unit 85.

Also, the display control unit 95 supplies the personal identification ID and the personal information supplied from the reader/writer 81 to the display unit 84 as necessary, and causes the display unit 84 to display the personal identification ID and the personal information. Using the displayed personal information and the like, the pharmacist or the like confirms the user's identity in an appropriate manner.

Further, if the mobile terminal device 15 to be provisionally registered is a terminal device to which a notification of a new registration and the like should be sent, the identity information is set to “1”. If not, the identity information is set to “0”.

In step S342, the communication unit 82 transmits the personal identification ID, the identity information, the pharmacy ID, and a provisional registration request to the data center 11 via the communication network 16.

Specifically, the request processing unit 92 generates the identity information from a signal supplied from the input unit 83 in response to an operation performed by the pharmacist. The request processing unit 92 also reads the pharmacy ID for identifying the pharmacy having the member store terminal device 12 installed therein from the recording unit 86, and generates a provisional registration request to request new provisional registration of the mobile terminal device 15 with respect to the user identified by the personal identification ID.

The request processing unit 92 then supplies the communication unit 82 with the personal identification ID supplied from the reader/writer 81, the identity information, the pharmacy ID read from the recording unit 86, and the provisional registration request, and instructs the communication unit 82 to perform transmission. The communication unit 82 then transmits the personal identification ID, the identity information, the pharmacy ID, and the provisional registration request supplied from the request processing unit 92, to the data center 11.

In step S351, the communication unit 42 of the data center 11 receives the personal identification ID, the identity information, the pharmacy ID, and the provisional registration request transmitted from the member store terminal device 12, and supplies the control unit 43 with the personal identification ID, the identity information, the pharmacy ID, and the provisional registration request.

In step S352, the generation unit 52 generates the individual-based terminal ID, the organization information, and the registration date information for the received personal identification ID.

In step S353, the management unit 51 supplies the individual-based terminal ID, the identity information, the organization information, and the registration date information to the recording unit 41, and causes the recording unit 41 to record the individual-based terminal ID, the identity information, the organization information, and the registration date information. Specifically, the management unit 51 causes the recording unit 41 to associate and record the individual-based terminal ID, the identity information, the organization information, and the registration date information with the same personal identification ID as the personal identification ID received in step S351 among the personal identification IDs recorded in the recording unit 41.

As the individual-based terminal ID, the identity information, the organization information, and the registration date information are associated with the personal identification ID and are recorded in the above manner, the provisional registration of the mobile terminal device 15 is completed.

After the provisional registration is completed, the individual-based terminal ID is transmitted in the procedure carried out in step S354, and the provisional registration process then comes to an end. However, the procedure in step S354 is similar to the procedure in step S24 in FIG. 7, and therefore, explanation of the procedure is not repeated herein.

Also, after the individual-based terminal ID is transmitted, the procedures in steps S343 through S345 are carried out in the member store terminal device 12, and the provisional registration request process then comes to an end. However, these procedures are similar to the procedures in steps S13 through S15 in FIG. 7, and therefore, explanation of them is not repeated herein.

Further, after the provisional registration request process is performed in the member store terminal device 12, and a QR code is displayed, the procedures in steps S361 through S363 are carried out as the read process by the mobile terminal device 15. It should be noted that the procedures in steps S361 through S363 are similar to the procedures in steps S31 through S33 in FIG. 7, and therefore, explanation of them is not repeated herein.

As described above, in the data center 11, the identity information transmitted together with the provisional registration request from the member store terminal device 12 is also associated and recorded with the individual-based terminal ID. With this, a mobile terminal device to which a notification of a new registration should be sent can be identified, and convenience of use can be improved while security is maintained.

<Registration Notification>

After the provisional registration of the mobile terminal device 15 is performed through the processes described above with reference to FIG. 17, the spouse operates the mobile terminal device 15, so that a process similar to the registration request process described above with reference to FIG. 8 is performed for the definitive registration. At this point of time, a process similar to the registration process described above with reference to FIG. 8 is performed in the data center 11.

Also, when the definitive registration of the mobile terminal device 15 is completed, the data center 11 notifies the user's mobile terminal device 14 of the new registration.

However, the notification to the mobile terminal device 14 may be made not at the point when the definitive registration is completed, but at the point when the provisional registration is completed or when the data center 11 receives the provisional registration request or the definitive registration request. The time to make a notification in the mobile terminal device 14 may be a time immediately after the notification is received, or the time when the application program for computerized medication record services is started by the mobile terminal device 14 for the first time after the above process was performed or when the data center 11 is accessed. Also, the notification destination may not be the mobile terminal device 14, and the notification method may be any method for sending a notification to a destination that is set as a destination to which a notification of a new registration should be sent. The notification may be sent to an account the user or the confirming person holds on the web site of the computerized medication record, for example.

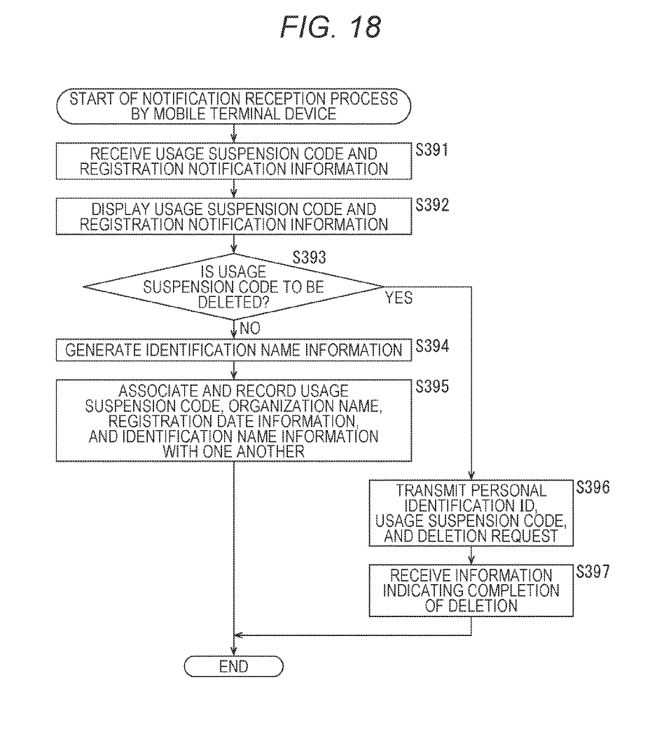

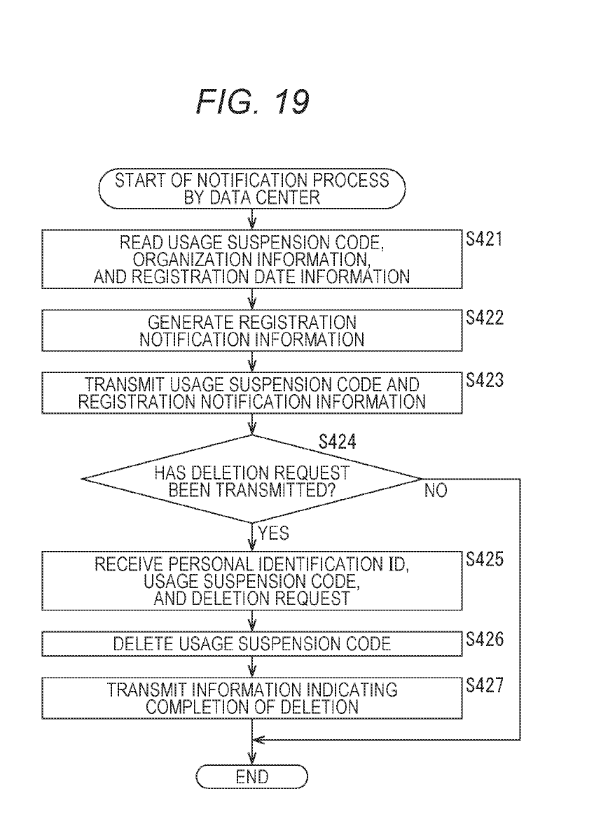

Referring now to FIGS. 18 and 19, the notification reception process to be performed by the mobile terminal device 14 to receive a notification from the data center 11, and the notification process to be performed by the data center 11 to send the notification to the mobile terminal device 14 are described.

Referring first to the flowchart in FIG. 18, the notification reception process to be performed by the mobile terminal device 14 is described.

In step S391, the communication unit 111 receives a usage suspension code and registration notification information transmitted from the data center 11, and supplies the usage suspension code and the registration notification information to the control unit 114. It should be noted that the registration notification information includes registration date information indicating the time and data at and on which the provisional registration process was performed as described above, and the organization name (pharmacy name) indicated by organization information.

In step S392, the display control unit 124 supplies the display unit 116 with the usage suspension code and the registration notification information supplied from the communication unit 111, and causes the display unit 116 to display the usage suspension code and the registration notification information. It should be noted that the usage suspension code may not be displayed, and only the registration notification information may be displayed.

As the usage suspension code and the registration notification information are displayed in the above manner, the user determines whether he/she knows the newly registered person, or the mobile terminal device 15, and operates the input unit 113 to issue a deletion instruction if necessary.

In step S393, the control unit 114 determines whether to delete the usage suspension code sent with the registration notification information, in accordance with a signal supplied from the input unit 113 in response to the operation performed by the user.

If the usage suspension code is determined not to be deleted in step S393, or if the new registration about which a notification has been sent with the registration notification information is a registration permitted by the user, the process moves on to step S394. In this case, the user inputs identification name information that is information for identifying the registered person, or the owner of the registered mobile terminal device 15, for example.

In step S394, the control unit 114 generates identification name information in accordance with the signal supplied from the input unit 113. Also, the information management unit 122 extracts the organization name and the registration date information from the registration notification information.

In step S395, the information management unit 122 supplies the recording unit 115 with the usage suspension code received in step S391, the organization name and the registration date information extracted from the registration notification information, and the identification name information, and causes the recording unit 115 to associate and record these pieces of information with one another. Under the control of the information management unit 122, the recording unit 115 records the usage suspension code, the organization name, the registration date information, and the identification name information, and the notification reception process then comes to an end.

If the usage suspension code is determined to be deleted in step S393, on the other hand, the communication unit 111 in step S396 transmits the personal identification ID, the usage suspension code, and a deletion request to the data center 11.

Specifically, the control unit 114 generates a deletion request to request deletion of the information related to the mobile terminal device 15 identified by the usage suspension code, and reads the personal identification ID for identifying the user from the recording unit 115.

The control unit 114 further supplies the communication unit 111 with the personal identification ID, the usage suspension code received in step S391, and the generated deletion request, and instructs the communication unit 111 to transmit the personal identification ID, the usage suspension code, and the deletion request to the data center 11. In turn, the communication unit 111 transmits the personal identification ID, the usage suspension code, and the deletion request supplied from the control unit 114, to the data center 11 via the communication network 16.

In the data center 11, the usage suspension code is deleted in accordance with the deletion request. Then, after the deletion is completed, information indicating the completion of the deletion is transmitted from the data center 11.

In step S397, the communication unit 111 receives the information that has been transmitted from the data center 11 and indicates the completion of the deletion, and supplies the information to the control unit 114. The display control unit 124 supplies the display unit 116 with the information supplied from the communication unit 111, and causes the display unit 116 to display the information. The notification reception process then comes to an end.

In the above manner, the mobile terminal device 14 receives the usage suspension code and the registration notification information about the newly registered mobile terminal device, and displays the usage suspension code and the registration notification information.

With this, the user can be made to check the new registration of the mobile terminal device without fail, and security can be maintained. Also, in a case where the mobile terminal device identified by the user suspension code has permission from the user, the usage suspension code, the organization name, the registration date information, and the identification name information are associated with each other and are recorded. Thus, the user suspension code can be readily identified, and convenience of use can be improved.

Referring now to the flowchart in FIG. 19, the notification process to be performed by the data center 11 is described. This notification process is started when the definitive registration of a mobile terminal device is completed as described above, for example.

In step S421, the management unit 51 selects a usage suspension code for which a registration notification has not yet been sent to the user, and reads, from the recording unit 41, the selected usage suspension code, and the organization information and the registration date information associated with the usage suspension code.

In step S422, the management unit 51 generates registration notification information in accordance with the read organization information and registration date information, and supplies the communication unit 42 with the registration notification information together with the usage suspension code. It should be noted that, in this case, the destination of transmission of the usage suspension code and the registration notification information is the mobile terminal device 14 identified by the individual-based terminal ID having the identity information “1”.

After the registration notification information is generated, the procedures in steps S423 through S427 are carried out, and the notification process then comes to an end. However, these procedures are similar to the procedures in steps S145 through S149 in FIG. 10, and therefore, explanation of them is not repeated herein. In this case, the destination of transmission of the usage suspension code and the registration notification information is the mobile terminal device 14, and the source of transmission of the deletion request is also the mobile terminal device 14.

In the above manner, the data center 11 generates registration notification information when there is a new registration, and then makes a registration notification. When there is a new registration, the user is notified of the registration as described above, so that unauthorized viewing of the medication history data can be prevented, and security and convenience can be improved.

It should be noted that although the usage suspension code, the organization name, the registration date information, and the identification name information are associated with one another and are recorded in the mobile terminal device 14 in the above described example, the usage suspension code, the organization name, the registration date information, and the identification name information may also be recorded on the IC card 13.

In such a case, the usage suspension code, the organization name, the registration date information, and the identification name information are transmitted in the form of a QR code or the like from the mobile terminal device 14 to the member store terminal device 12, for example. The usage suspension code, the organization name, the registration date information, and the identification name information are then transmitted from the member store terminal device 12 to the IC card 13 through non-contact communication or the like, and are recorded on the IC card 13. Alternatively, the mobile terminal device 14 may record the usage suspension code, the organization name, the registration date information, and the identification name information directly on the IC card 13 through non-contact communication or the like.

<Deletion of a Personally-Set Terminal Code and an Individual-Based Terminal ID>

As the usage suspension code, the organization name, the registration date information, and the identification name information are associated with one another and are recorded into the mobile terminal device 14 of the user, the user can easily select a desired usage suspension code (individual-based terminal ID) from those pieces of information, and invalidate the right to access the medication history data.

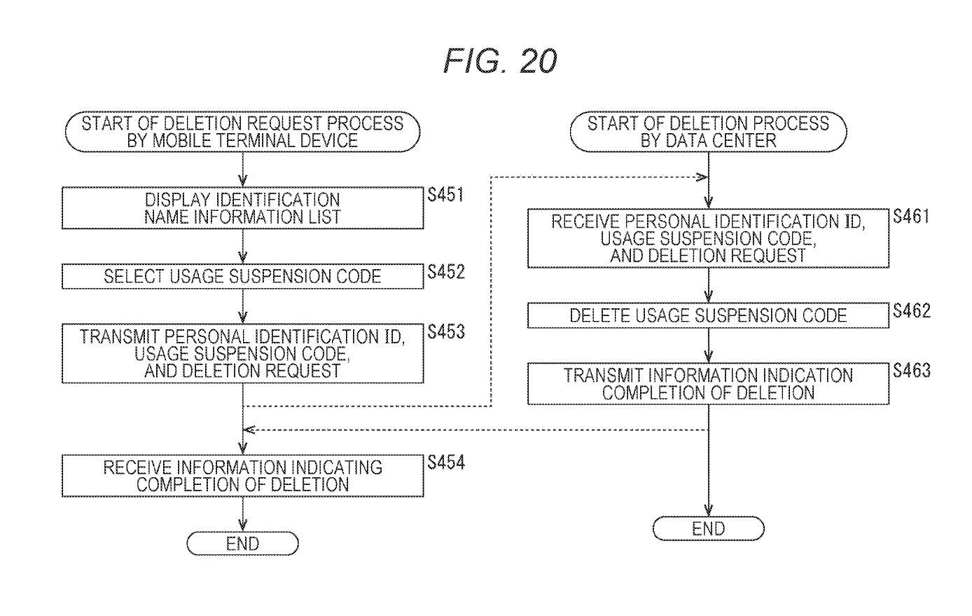

The following is a description of the processes to be performed when the user operates the mobile terminal device 14 to invalidate the medication history data access right of a desired mobile terminal device, with reference to FIG. 20. That is, a deletion request process to be performed by the mobile terminal device 14, and a deletion process to be performed by the data center 11 are described below, with reference to the flowchart in FIG. 20.

In step S451, the display control unit 124 causes the display unit 116 to display an identification name information list.

For example, the information management unit 122 reads the usage suspension codes recorded in the recording unit 115 in accordance with the user's operation, and the organization name, the registration date information, and the identification name information associated with the usage suspension codes. In this step, all the usage suspension codes recorded in the recording unit 115 are read.

The control unit 114 generates an identification name information list containing the organization names, the registration date information, the identification name information about the respective read usage suspension codes. Alternatively, the identification name information list may contain the usage suspension codes.

The display control unit 124 causes the display unit 116 to display the generated identification name information list. As the identification name information list is displayed, the user operates the input unit 113, to select desired identification name information from the identification name information list.

After the identification name information is selected by the user, the control unit 114 in step S452 selects the usage suspension code to be deleted, which is the usage suspension code associated with the identification name information selected by the user, in accordance with a signal supplied from the input unit 113.

After the usage suspension code is selected, the procedures in steps S453 and S454 are carried out, and the deletion request process then comes to an end. However, these procedures are similar to the procedures in steps S396 and S397 in FIG. 18, and therefore, explanation of them is not repeated herein.

Also, when the usage suspension code is selected by the mobile terminal device 14, and the personal identification ID, the usage suspension code, and a deletion request are transmitted, the procedures in steps S461 through S463 are carried out as the deletion process in the data center 11. It should be noted that the procedures in steps S461 through S463 are similar to the procedures in steps S425 through S427 in FIG. 19, and therefore, explanation of them is not repeated herein.

In the above manner, the mobile terminal device 14 generates and displays an identification name information list in accordance with the organization names, the registration date information, and the identification name information associated and recorded with usage suspension codes, and prompts the user to select a desired usage suspension code.

As the organization names, the registration date information, and the identification name information are displayed as clues in the above manner, the user can be made to select a desired usage suspension code more easily and accurately, and thus, convenience of use can be improved.

### Third Embodiment

<Recording of Identification Name Information>

Meanwhile, although identification name information is recorded in the data center 11 in the first modification of the first embodiment, the hash values of identification name information, instead of the identification name information, may be recorded to further improve security.

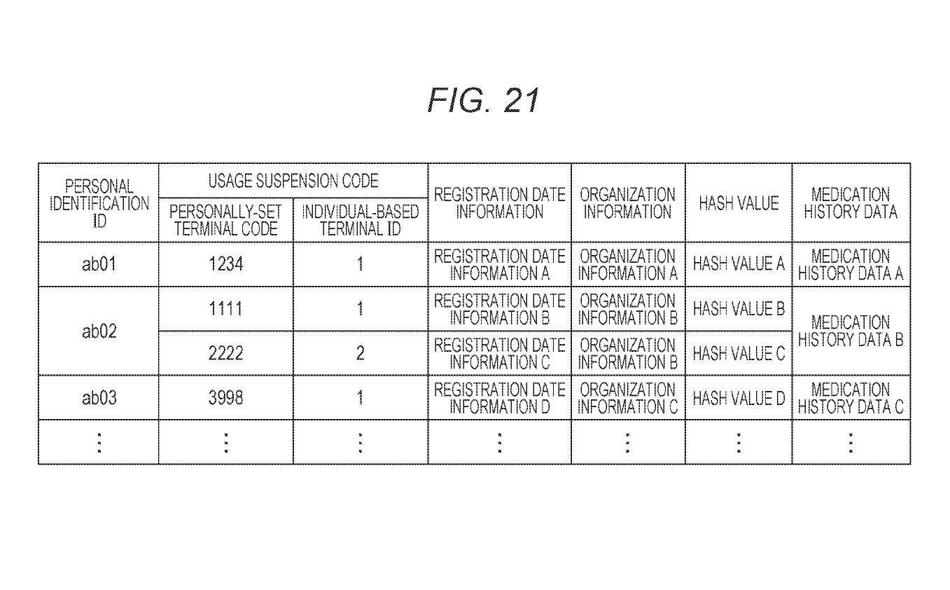

In such a case, personally-set terminal codes, individual-based terminal IDs, registration date information, organization information, hash values, and medication history data are associated with personal identification IDs as shown in FIG. 21, for example, and are recorded in the recording unit 41 of the data center 11.

It should be noted that one or more individual-based terminal IDs are associated with each personal identification ID. Also, a personally-set terminal code, registration date information, organization information, and a hash value are associated with each of the individual-based terminal IDs associated with a personal identification ID.

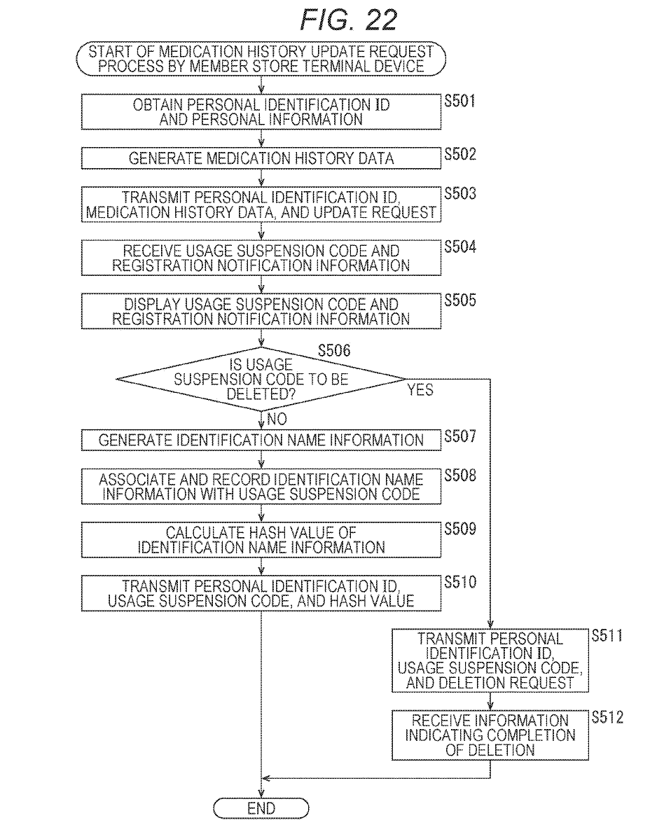

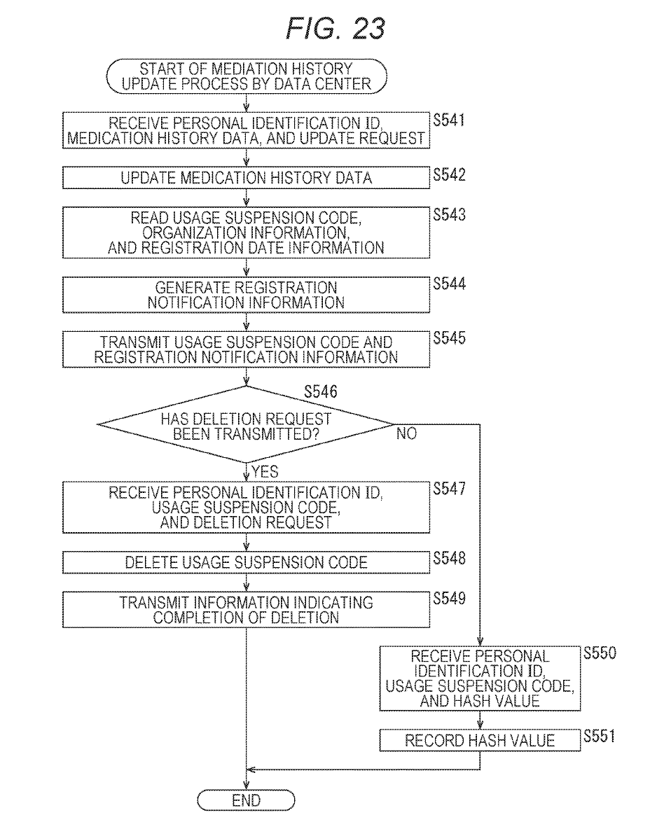

In a case where hash values are recorded in the data center 11 in this manner, the processes shown in FIGS. 22 and 23 are performed as the processes equivalent to the medication history update request process shown in FIG. 9 and the medication history update process shown in FIG. 10. It should be noted that the description below is based on the assumption that the mobile terminal device 14 is not used, as in the first embodiment.

Referring first to the flowchart in FIG. 22, the medication history update request process to be performed by the member store terminal device 12 is described. It should be noted that the procedures in steps S501 through S508 are similar to the procedures in steps S101 through S108 in FIG. 9, and therefore, explanation of them is not repeated herein.

After the usage suspension code and the identification name information are associated with each other and are recorded on the IC card 13 of the user in step S508, the data generation unit 94 in step S509 performs a hashing operation on the identification name information, to calculate the hash value of the identification name information.

Also, the request processing unit 92 supplies the personal identification ID, the usage suspension code, and the hash value to the communication unit 82. The usage suspension code supplied to the communication unit 82 in this step has been recorded in the procedure in step S508.

In step S510, the communication unit 82 transmits the personal identification ID, the usage suspension code, and the hash value supplied from the request processing unit 92, to the data center 11 via the communication network 16, and requests recording of the hash value. The medication history update request process then comes to an end.

If the usage suspension code is determined to be deleted in step S506, on the other hand, the procedures in steps S511 and S512 are carried out, and the medication history update request process then comes to an end. However, these procedures are similar to the procedures in steps S109 and S110 in FIG. 9, and therefore, explanation of them is not repeated herein.

In the above manner, the member store terminal device 12 causes the IC card 13 to record the usage suspension code and the identification name information, and further calculates the hash value of the identification name information. The member store terminal device 12 then transmits the personal identification ID, the usage suspension code, and the hash value to the data center 11, and causes the data center 11 to record the hash value.

As hash values are recorded in the data center 11 as described above, it is possible to provide various kinds of services using the hash values while improving security. Thus, convenience of use can also be improved.

Referring now to the flowchart in FIG. 23, the medication history update process to be performed by the data center 11 is described. It should be noted that the procedures in steps S541 through S549 are similar to the procedures in steps S141 through S149 in FIG. 10, and therefore, explanation of them is not repeated herein.

In addition, if any deletion request has not been transmitted in step S546, or in a case where the personal identification ID, the usage suspension code, and the hash value are transmitted by the procedure in step S510 in FIG. 22, the procedure in step S550 is carried out.

In step S550, the communication unit 42 receives the personal identification ID, the usage suspension code, and the hash value transmitted from the member store terminal device 12, and supplies the control unit 43 with the personal identification ID, the usage suspension code, and the hash value.

In step S551, the management unit 51 supplies the recording unit 41 with the hash value supplied from the communication unit 42, and causes the recording unit 41 to record the hash value.

Specifically, the management unit 51 controls the recording unit 41 so that the hash value is associated and recorded with the usage suspension code identified by the personal identification ID and the usage suspension code supplied from the communication unit 42 among the usage suspension codes recorded in the recording unit 41. Under the control of the management unit 51, the recording unit 41 associates and records the hash value with the usage suspension code designated by the management unit 51. After the hash value is recorded, the medication history update process comes to an end.

In the above manner, the data center 11 associates and records a hash value received from the member store terminal device 12 with a personal identification ID and a usage suspension code. As a result, it becomes possible to provide services using hash values while improving security. Thus, convenience of use can be improved.

In a case where hash values are recorded in the data center 11 as described above, the user can also have a desired usage suspension code (individual-based terminal ID) deleted at the pharmacy, using the IC card 13. In such a case, processes similar to the deletion request process and the deletion process described above with reference to FIG. 11 are performed.

<Reissuance of an IC Card>

Also, as hash values are recorded in the data center 11, the information recorded on the IC card 13 can be recorded on a new IC card 13 in a case where the user has lost the IC card 13 and needs to have an IC card 13 reissued. In this manner, the user and the spouse can view the medication history data without new registration of their mobile terminal devices, and thus, convenience of use can be improved.

It should be noted that, in this example, an in-pharmacy personal identification number for identifying the user only inside a service providing store such as a pharmacy is used at the service providing store.

Specifically, the name of each user is associated with the in-pharmacy personal identification number for identifying the user and is recorded together with the in-pharmacy personal identification number in the recording unit 86 of the member store terminal device 12. Also, in the recording unit 86, for example, information related to the user, such as information related to prescriptions and the medication history, is associated with the name and the in-pharmacy personal identification number of the user, and is managed.

Further, in the data center 11, each pharmacy as a service providing store is associated with the pharmacy ID for identifying the pharmacy, personal identification IDs, and in-pharmacy personal identification numbers recorded in the recording unit 41. Accordingly, in the data center 11, the personal identification ID of the user being managed under the in-pharmacy personal identification number can be identified from the pharmacy ID and the in-pharmacy personal identification number inside the pharmacy identified by the pharmacy ID.

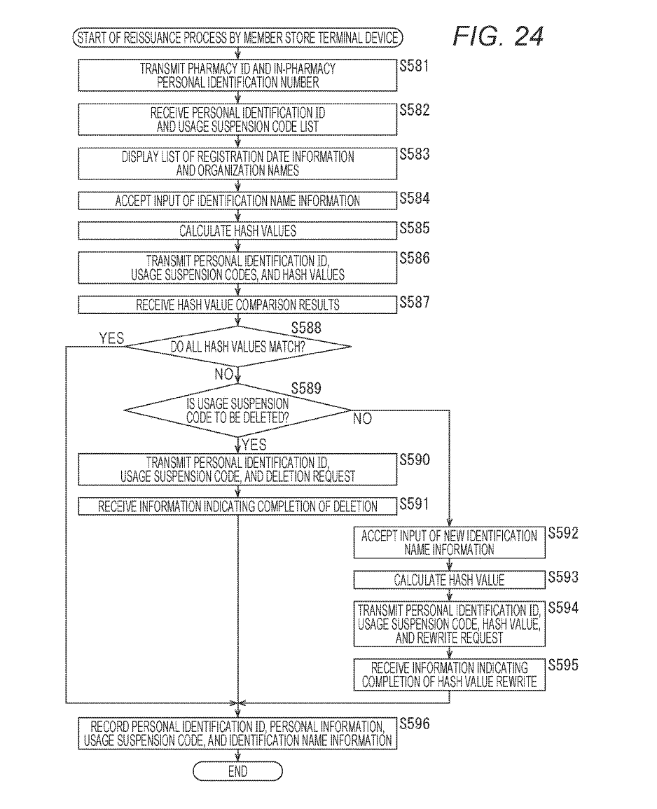

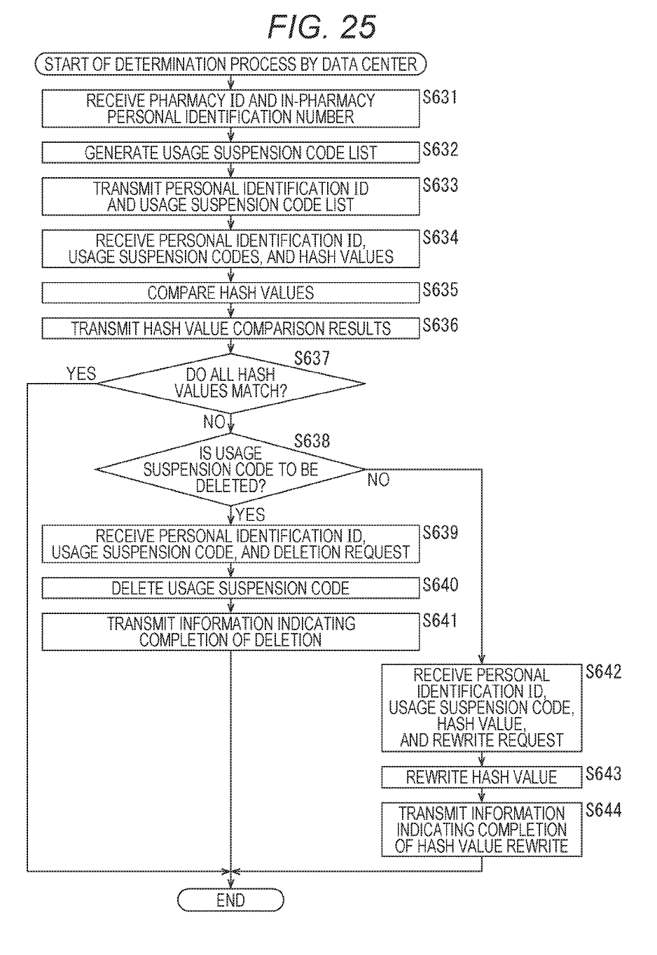

The following is a description of the processes to be performed in a case where the user receives a reissued IC card 13, with reference to FIGS. 24 and 25.

Referring first to the flowchart in FIG. 24, the reissuance process to be performed by the member store terminal device 12 is described.

The user visits the pharmacy, and asks the pharmacist or the like in charge for reissuance of the IC card 13 or the like. The pharmacist or the like asks the user to present an identification, and confirms the identity of the user. The pharmacist or the like then operates the input unit 83, to detect the in-pharmacy personal identification number associated with the name of the user.

That is, in accordance with a signal from the input unit 83, the request processing unit 92 reads, from the recording unit 86, the in-pharmacy personal identification number associated with the name of the user. The request processing unit 92 also reads the pharmacy ID from the recording unit 86.

In step S581, the communication unit 82 then transmits the pharmacy ID and the in-pharmacy personal identification number to the data center 11.

Specifically, the request processing unit 92 supplies the communication unit 82 with the read pharmacy ID and the in-pharmacy personal identification number, and instructs the communication unit 82 to transmit the pharmacy ID and the in-pharmacy personal identification number to the data center 11. The communication unit 82 transmits the pharmacy ID and the in-pharmacy personal identification number supplied from the request processing unit 92, to the data center 11 via the communication network 16. The communication unit 82 also requests transmission of a usage suspension code list.

After the pharmacy ID and the in-pharmacy personal identification number are transmitted, the personal identification ID is identified from the pharmacy ID and the in-pharmacy personal identification number in the data center 11. A usage suspension code list that contains the usage suspension code associated with the personal identification ID, the registration date information, and the organization name indicated by the organization information is then generated, and the personal identification ID and the usage suspension code list are transmitted to the member store terminal device 12.

In step S582, the communication unit 82 receives the personal identification ID and the usage suspension code list transmitted from the data center 11, and supplies the personal identification ID and the usage suspension code list to the control unit 85.

In step S583, the display control unit 95 supplies the display unit 84 with the usage suspension code list supplied from the communication unit 82 minus the usage suspension codes, or with the registration date information and the organization names. The display control unit 95 then causes the display unit 84 to display the registration date information and the organization names in the form of a list. It should be noted that the usage suspension code list may be displayed as it is.

After the registration date information and the organization names are displayed on the display unit 84, the control unit 85 in step S584 accepts an input of identification name information from the user.

Using the registration date information and the organization names displayed on the display unit 84 as clues, the user remembers the identification name information the user set in the past for the usage suspension codes associated with the registration date information and the organization names. Then, the user, or the pharmacist or the like who has received an instruction from the user operates the input unit 83, to input identification name information for each set of registration date information and an organization name.

The control unit 85 associates the respective usage suspension codes in the usage suspension code list with the identification name information that is input by the user or the like, and holds the usage suspension codes and the identification name information.

In step S585, the data generation unit 94 performs a hashing operation on each piece of the identification name information supplied from the input unit 83, and calculates the hash values of the identification name information. In this manner, the hash values of the identification name information associated with the respective usage suspension codes are obtained.

The request processing unit 92 supplies the personal identification ID, the usage suspension codes, and the hash values to the communication unit 82, and instructs the communication unit 82 to transmit the personal identification ID, the usage suspension codes, and the hash values to the data center 11. In this step, the usage suspension codes and the hash values associated with each other are supplied to the communication unit 82.

In step S586, the communication unit 82 transmits the personal identification ID, the usage suspension codes, and the hash values supplied from the request processing unit 92, to the data center 11 via the communication network 16, and requests hash value comparisons.

In the data center 11 that has received the hash values, a received hash value is compared with a hash value recorded in the recording unit 41 for each usage suspension code, and the results of the comparisons are transmitted to the member store terminal device 12.

In step S587, the communication unit 82 receives the hash value comparison results transmitted from the data center 11, and supplies the hash value comparison results to the control unit 85. Also, the display control unit 95 supplies the display unit 84 with the hash value comparison results supplied from the communication unit 82, and causes the display unit 84 to display the hash value comparison results, as necessary.

In step S588, in accordance with the hash value comparison results supplied from the communication unit 82, the control unit 85 determines whether the hash values match with respect to all the usage suspension codes.

If it is determined in step S588 that the hash values match with respect to all the usage suspension codes, the process moves on to step S596.

If it is determined in step S588 that the hash values do not match with respect to a usage suspension code, on the other hand, the control unit 85 in step S589 determines whether the usage suspension code having hash value mismatching is to be deleted, in accordance with a signal supplied from the input unit 83.

For example, when the hash value comparison results are displayed on the display unit 84, the user and the pharmacist check the displayed comparison results. If the hash values do not match with respect to a usage suspension code, identification name information is again input, and the above described procedures in step S584 through S587 may be repeated.

Also, in a case where there is a usage suspension code having hash value mismatching, the user chooses to delete the usage suspension code or to reallocate identification name information to the usage suspension code. For example, if the user chooses to delete the usage suspension code having hash value mismatching, and the user or the pharmacist or the like operates the input unit 83 in accordance with the choice, the control unit 85 determines to delete the usage suspension code in accordance with a signal from the input unit 83.

If the usage suspension code is determined to be deleted in step S589, the request processing unit 92 generates a request for deletion of the usage suspension code having hash value mismatching, or deletion of the personally-set terminal code and the individual-based terminal ID. The request processing unit 92 then supplies the communication unit 82 with the personal identification ID, the usage suspension code to be deleted, and the deletion request, and the process moves on to step S590.

In step S590, the communication unit 82 transmits the personal identification ID, the usage suspension code, and the deletion request supplied from the request processing unit 92, to the data center 11 via the communication network 16.

After the deletion request is transmitted, the usage suspension code, which is the individual-based terminal ID and the personally-set terminal code, is deleted in accordance with the deletion request in the data center 11. The data center 11 then transmits information indicating the completion of the deletion to the member store terminal device 12.

In step S591, the communication unit 82 receives the information that has been transmitted from the data center 11 and indicates the completion of the deletion, and supplies the information to the control unit 85. The display control unit 95 supplies the display unit 84 with the information that has been supplied from the communication unit 82 and indicates the completion of the deletion. The display control unit 95 causes the display unit 84 to display the information.

As the information indication the completion of the deletion is displayed, the control unit 85 deletes the usage suspension code deleted by the data center 11 among the usage suspension codes that have been received in the procedure in step S582 and are stored. The process then moves on to step S596.

If the usage suspension code is determined not to be deleted in step S589, on the other hand, or in a case where identification name information is newly allocated to the usage suspension code having hash value mismatching, the process moves on to step S592.

In step S592, the control unit 85 accepts an input of new identification name information.

The user, or the pharmacists or the like who has received an instruction from the user operates the input unit 83, to input new identification name information for the usage suspension code having hash value mismatching. In this case, the user can identify the spouse (the mobile terminal device) to which the usage suspension code having hash value mismatching is allotted, in accordance with the registration date information and the organization name. Accordingly, the user can allocate appropriate identification name information to the usage suspension code.

In step S593, the data generation unit 94 performs a hashing operation on the identification name information supplied from the input unit 83, and calculates the hash value of the identification name information.

The request processing unit 92 generates a rewrite request to request rewrite of the hash value, and also supplies the communication unit 82 with the personal identification ID, the usage suspension code having hash value mismatching, the hash value of the newly input identification name information, and the rewrite request.

In step S594, the communication unit 82 transmits the personal identification ID, the usage suspension code, the hash value, and the rewrite request supplied from the request processing unit 92, to the data center 11 via the communication network 16.

In the data center 11, the hash value is rewritten in accordance with the rewrite request, and information indicating the completion of the rewrite of the hash value is transmitted to the member store terminal device 12.

In step S595, the communication unit 82 receives the information that has been transmitted from the data center 11 and indicates the completion of the rewrite of the hash value, and supplies the information to the control unit 85. The display control unit 95 supplies the display unit 84 with the information that has been supplied from the communication unit 82 and indicates the completion of the rewrite of the hash value. The display control unit 95 causes the display unit 84 to display the information.

As the information indication the completion of the rewrite of the hash value is displayed, the control unit 85 associates the new identification name information with the usage suspension code having the new identification name information allocated thereto among the usage suspension codes that have been received in the procedure in step S582 and are stored. The process then moves on to step S596.

In step S596, the recording control unit 93 controls the reader/writer 81, and causes the reader/writer 81 to record the personal identification ID, the personal information, the usage suspension code, and the identification name information on the newly issued IC card 13. That is, the recording control unit 93 supplies the reader/writer 81 with the usage suspension code and the identification name information that are associated with each other by the control unit 85 and are stored, and the personal identification ID and the personal information. The recording control unit 93 then instructs the reader/writer 81 to record the usage suspension code, the identification name information, the personal identification ID, and the personal information on the reissued IC card 13. It should be noted that personal information is input by the pharmacist or the like if necessary.

The reader/writer 81 transmits the personal identification ID, the personal information, the usage suspension code, and the identification name information supplied from the recording control unit 93, to the reissued IC card 13 through non-contact communication, and causes the reissued IC card 13 to record the personal identification ID, the personal information, the usage suspension code, and the identification name information. The reissuance process then comes to an end. At this point, the usage suspension code and the identification name information associated with each other are recorded on the IC card 13.

In the above manner, the member store terminal device 12 verifies the identification name information for each usage suspension code, using the hash value of the identification name information. The member store terminal device 12 then causes the reissued IC card 13 to record the usage suspension code and the identification name information associated with each other. As verification using hash values is performed in the above manner, the reissued IC card 13 can be made as close as possible to the original IC card 13 while security is maintained. Thus, convenience of use can be improved.

In addition, when the reissuance process described above with reference to FIG. 24 is performed, and a hash value comparison request is issued, a determination process is performed in the data center 11. Referring now to the flowchart in FIG. 25, the determination process to be performed by the data center 11 is described.

In step S631, the communication unit 42 receives the pharmacy ID and the in-pharmacy personal identification number transmitted from the member store terminal device 12 by the procedure in step S581 in FIG. 24, and supplies the pharmacy ID and the in-pharmacy personal identification number to the control unit 43.

In accordance with the pharmacy ID and the in-pharmacy personal identification number supplied from the communication unit 42, the management unit 51 identifies the personal identification ID that is associated with the pharmacy ID and the in-pharmacy personal identification number and is recorded in the recording unit 41.

In step S632, the management unit 51 reads, from the recording unit 41, the identified personal identification ID, and the usage suspension code, the registration date information, and the organization information associated with the personal identification ID. The management unit 51 then generates a usage suspension code list. Here, the usage suspension code list contains usage suspension codes, registration date information, and the organization names identified by organization information.

The management unit 51 supplies the personal identification ID and the generated usage suspension code list to the communication unit 42, and instructs the communication unit 42 to transmit the personal identification ID and the usage suspension code list to the member store terminal device 12.

In step S633, the communication unit 42 transmits the personal identification ID and the usage suspension code list supplied from the management unit 51, to the member store terminal device 12 via the communication network 16.

After that, when identification name information is input to the member store terminal device 12, the personal identification ID, usage suspension codes, and hash values are transmitted from the member store terminal device 12 by the procedure in step S586 in FIG. 24.

In step S634, the communication unit 42 receives the personal identification ID, the usage suspension codes, and the hash values transmitted from the member store terminal device 12, and supplies the control unit 43 with the personal identification ID, the usage suspension codes, and the hash values.

In step S635, the control unit 43 compares the hash values supplied from the communication unit 42 with the hash values that are associated with the personal identification ID and the usage suspension codes supplied from the communication unit 42 and are recorded in the recording unit 41. The control unit 43 then supplies the comparison results to the communication unit 42.

In step S636, the communication unit 42 transmits the hash value comparison results supplied from the control unit 43, to the member store terminal device 12 via the communication network 16.

In step S637, in accordance with the results of the hash value comparisons performed in step S635, the control unit 43 determines whether the hash values match with respect to all the usage suspension codes.

If it is determined in step S637 that the hash values match with respect to all the usage suspension codes, the determination process comes to an end.

If it is determined in step S637 that the hash values do not match with respect to a usage suspension code, on the other hand, the control unit 43 in step S638 determines whether the usage suspension code is to be deleted. For example, in a case where a deletion request is transmitted from the member store terminal device 12, the usage suspension code is determined to be deleted.

If the usage suspension code is determined to be deleted in step S638, or in a case where a deletion request is transmitted from the member store terminal device 12 by the procedure in step S590 in FIG. 24, the process moves on to step S639.

In step S639, the communication unit 42 receives the personal identification ID, the usage suspension code, and the deletion request transmitted from the member store terminal device 12, and supplies the control unit 43 with the personal identification ID, the usage suspension code, and the deletion request.

After the deletion request is received, the procedures in steps S640 and S641 are carried out, and the determination process then comes to an end. However, these procedures are similar to the procedures in steps S148 and S149 in FIG. 10, and therefore, explanation of them is not repeated herein.

If the usage suspension code is determined not to be deleted in step S638, on the other hand, a rewrite request is transmitted from the member store terminal device 12 by the procedure in step S594 in FIG. 24, and therefore, the process moves on to step S642.

In step S642, the communication unit 42 receives the personal identification ID, the usage suspension code, the hash value, and the rewrite request transmitted from the member store terminal device 12, and supplies the control unit 43 with the personal identification ID, the usage suspension code, the hash value, and the rewrite request.

In step S643, the management unit 51 rewrites the hash value in accordance with the rewrite request supplied from the communication unit 42. Specifically, the management unit 51 replaces the hash value that is associated with the personal identification ID and the usage suspension code supplied from the communication unit 42 and is recorded in the recording unit 41, with the hash value supplied from the communication unit 42.

When the rewrite of the hash value is completed, the management unit 51 supplies the communication unit 42 with information indicating the completion of the rewrite of the hash value, and instructs the communication unit 42 to transmit the information to the member store terminal device 12.

In step S644, the communication unit 42 transmits the information that has been supplied from the management unit 51 and indicates the completion of the rewrite of the hash value, to the member store terminal device 12 via the communication network 16. The determination process then comes to an end.

In the above manner, the data center 11 performs hash value verification in accordance with a request from the member store terminal device 12. The data center 11 also rewrites a hash value in accordance with a request, or deletes a usage suspension code. In this manner, the environment of usage of the reissued IC card 13 can be made as close as possible to the original environment while security is maintained. Thus, convenience of use can be improved.

It should be noted that processes similar to the processes described in the third embodiment may be performed in the above described second embodiment so that the user can record a usage suspension code and identification name information into a new mobile terminal device 14 after losing the original mobile terminal device 14.

In such a case, the mobile terminal device 14 receives a usage suspension code list from the data center 11, accepts an input of identification name information from the user, and calculates a hash value of the input identification name information. The mobile terminal device 14 then transmits the calculated hash value to the data center 11, and receives a hash value determination result. In accordance with the determination result, the mobile terminal device 14 records a usage suspension code associated with the identification name information, requests deletion of a usage suspension code, or replaces the identification name information with new identification name information.

### First Modification of the Third Embodiment

<Usage Suspension Code List>

Meanwhile, although a usage suspension code list containing usage suspension codes, registration date information, and organization names is generated in step S633 in FIG. 25, the usage suspension code list may further include location information about organizations such as pharmacies associated with the organization names.

In such a case, at the time of provisional registration, for example, the location information indicating the location of the pharmacy is transmitted together with a provisional registration request to the data center 11.

Specifically, in step S12 in FIG. 7, the personal identification ID, the pharmacy ID, the location information, and the provisional registration request are transmitted from the member store terminal device 12 to the data center 11. Also, in step S23, the registration date information, the organization information, and the location information, which are associated with the individual-based terminal ID, are recorded into the recording unit 41. Here, the location information is information indicating the latitude and the longitude of the pharmacy, for example.

In a case where the location information about the pharmacy is also recorded in this manner, a usage suspension code list containing usage suspension codes, registration date information, organization names, and location information is generated in the data center 11 in step S632 in FIG. 25.

Then, in the member store terminal device 12, a list of registration date information and organization names is displayed in step S583 in FIG. 24. In this list, the organization names are associated with location information. When the user or the like designates an organization name by operating the input unit 83, the control unit 85 obtains map data from a server (not shown) or the like via the communication network 16, for example, in accordance with the location information associated with the designated organization name. The map data includes the location indicated by the location information. Then, from the obtained map data and the location information, the control unit 85 generates a map on which the location of the pharmacy is pointed out, and the display control unit 95 supplies the generated map to the display unit 84 and causes the display unit 84 to display the map.

As a result, the user can check the map showing the location of the pharmacy, and can also remember identification name information by using the map as a clue. It should be noted that, instead of a map generated from location information, the address or the like of the location identified by location information may be displayed, or a map and the address may be displayed.

### Fourth Embodiment

<Provisional Registration>

Although the member store terminal device 12 performs the provisional registration request process as a process at the time of the provisional registration described above with reference to FIG. 7, the provisional registration request process may be performed by a mobile terminal device already registered in the data center 11, such as the mobile terminal device 14.

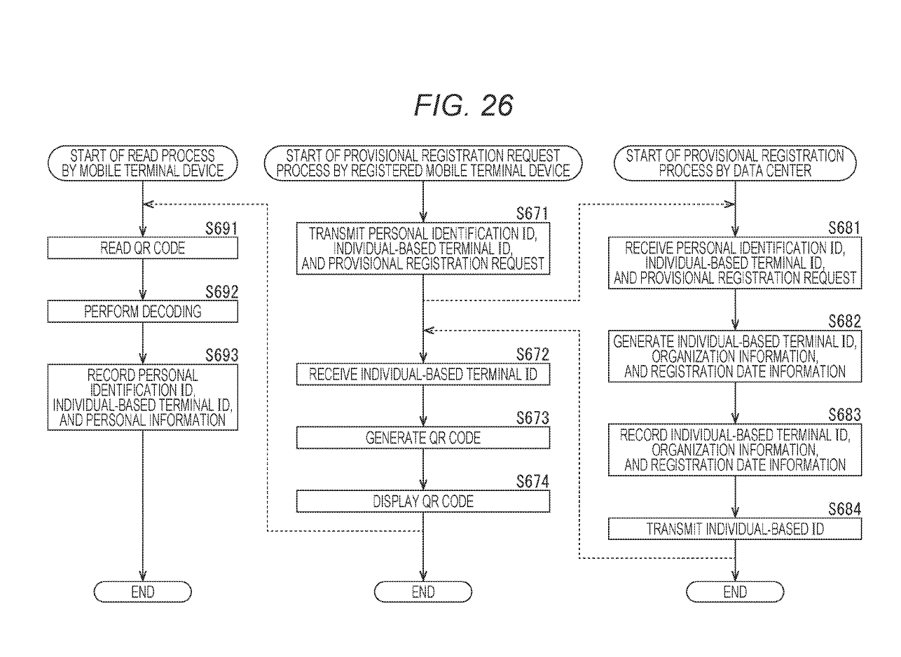

Referring now to the flowchart in FIG. 26, the read process to be performed by the mobile terminal device 15, the provisional registration request process to be performed by the registered mobile terminal device 14, and the provisional registration process to be performed by the data center 11 at the time of provisional registration in such a case are described.

It should be noted that, in this example, the mobile terminal device 14 has been registered in the data center 11 by the above described read process and registration request process, and medication history data and the like can be viewed on the mobile terminal device 14. Therefore, the personal identification ID, the individual-based terminal ID, and the personal information are recorded into the recording unit 115 of the mobile terminal device 14 by the procedure in step S33 of the read process.

When the provisional registration request process is started, the communication unit 111 in step S671 transmits the personal identification ID, the individual-based terminal ID, and a provisional registration request to the data center 11 via the communication network 16.

Specifically, the control unit 114 of the mobile terminal device 14 obtains the personal identification ID, the individual-based terminal ID, and the personal information from the recording unit 115. The control unit 114 also generates a provisional registration request to request new provisional registration of a mobile terminal device 15, and supplies the communication unit 111 with the generated provisional registration request, and the obtained personal identification ID and individual-based terminal ID. The control unit 114 instructs the communication unit 111 to perform transmission. The communication unit 111 then transmits the personal identification ID, the individual-based terminal ID, and the provisional registration request supplied from the control unit 114, to the data center 11.

In step S681, the communication unit 42 of the data center 11 receives the personal identification ID, the individual-based terminal ID, and the provisional registration request transmitted from the mobile terminal device 14, and supplies the control unit 43 with the personal identification ID, the individual-based terminal ID, and the provisional registration request.

In step S682, the generation unit 52 generates an individual-based terminal ID, organization information, and registration date information for the received personal identification ID.

Specifically, the management unit 51 instructs the generation unit 52 to generate the individual-based terminal ID, the organization information, and the registration date information, in accordance with the received provisional registration request. The generation unit 52 generates a new individual-based terminal ID in accordance with the instruction.

The generation unit 52 also generates information indicating the current time and date as the registration date information in accordance with the instruction from the management unit 51, and sets the individual-based terminal ID received by the communication unit 42 as the organization information. That is, in this example, the individual-based terminal ID is transmitted, instead of the pharmacy ID transmitted in the provisional registration request process performed by the member store terminal device 12. Therefore, in step S682, the individual-based terminal ID is regarded as the organization information. It should be noted that the information regarded as the organization information is not necessarily the individual-based terminal ID, but may be any kind of information with which the mobile terminal device 14 can be identified.

After the individual-based terminal ID, the organization information, and the registration date information are generated in the above manner, the procedures in steps S683 and S684 are carried out, and the provisional registration process then comes to an end. However, these procedures are similar to the procedures in steps S23 and S24 in FIG. 7, and therefore, explanation of them is not repeated herein.

Meanwhile, in step S672, the communication unit 111 of the mobile terminal device 14 receives the individual-based terminal ID transmitted from the data center 11, and supplies the individual-based terminal ID to the control unit 114.

In step S673, the control unit 114 generates a QR code in accordance with the individual-based terminal ID received in step S672 and the personal identification ID and the personal information read from the recording unit 115 in step S671, and supplies the QR code to the display unit 116. The QR code generated by the control unit 114 contains information that is the personal identification ID, the individual-based terminal ID, and the personal information.

In step S674, the display unit 116 displays the QR code supplied from the control unit 114, and the provisional registration request process then comes to an end. Specifically, as the display unit 116 is made to display the QR code, the control unit 114 performs short-range communication with the mobile terminal device 15 through the QR code, and transmits the information contained in the QR code to the mobile terminal device 15. The process of displaying such a QR code on the display unit 116 can also be regarded as a process of displaying the personal identification ID, the individual-based terminal ID, and the personal information indicated by the QR code on the display unit 116.

After the QR code is displayed on the display unit 116, the procedures in steps S691 through S693 are carried out, and the read process then comes to an end. However, these procedures are similar to the procedures in steps S31 through S33 in FIG. 7, and therefore, explanation of them is not repeated herein.

In the above manner, the mobile terminal device 14 requests the data center 11 to provisionally register the mobile terminal device 15, using the personal identification ID and the personal information recorded in the mobile terminal device 14. In this manner, the registered mobile terminal device 14 can also be used in provisionally registering another mobile terminal device. Thus, convenience of use can be improved.

Alternatively, the mobile terminal device 14 may perform non-contact communication with the IC card 13, to obtain the personal identification ID and the personal information from the IC card 13. Using the obtained personal identification ID, the mobile terminal device 14 may carry out the procedure in step S671.

Further, in a case where the mobile terminal device 14 accesses the data center 11 by transmitting the personal identification ID to the data center 11, and requests the data center 11 to allow viewing of medication history data or update the medication history data, a usage suspension code and registration notification information may be received from the data center 11. In such a case, a process similar to the medication history update request process shown in FIG. 9, for example, is performed by the mobile terminal device 14.

### Fifth Embodiment

<Medication History Update and Registration Notification>

Also, in a case where a viewing permission/prohibition flag indicating the validity/invalidity of a right to access medication history data is associated with each usage suspension code and is recorded in the recording unit 41 of the data center 11 as described above, the viewing permission/prohibition flag may be changed to invalidate the access right. For example, in a case where the access right is valid, or where there is the right to access the medication history data, the viewing permission/prohibition flag is set to “1”. In a case where the access right is invalid, the viewing permission/prohibition flag is set to “0”.

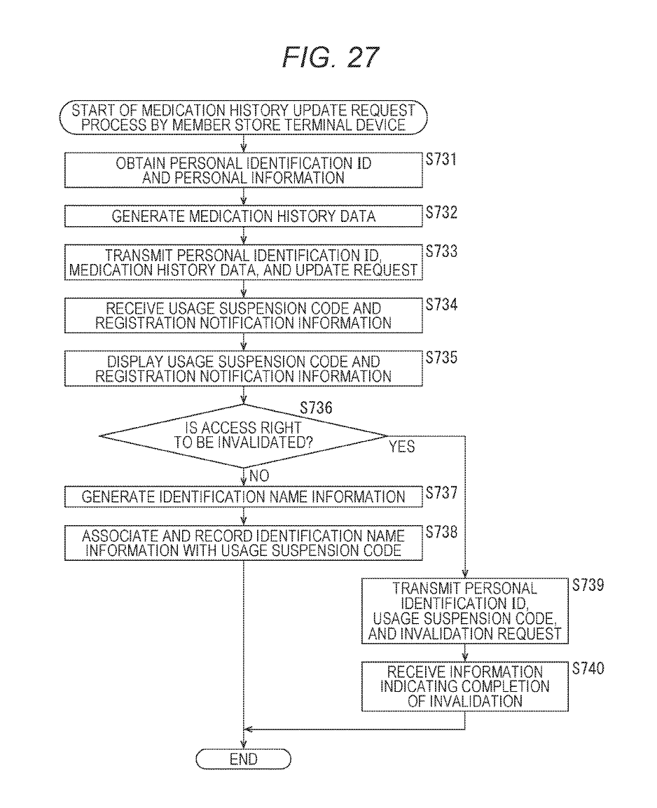

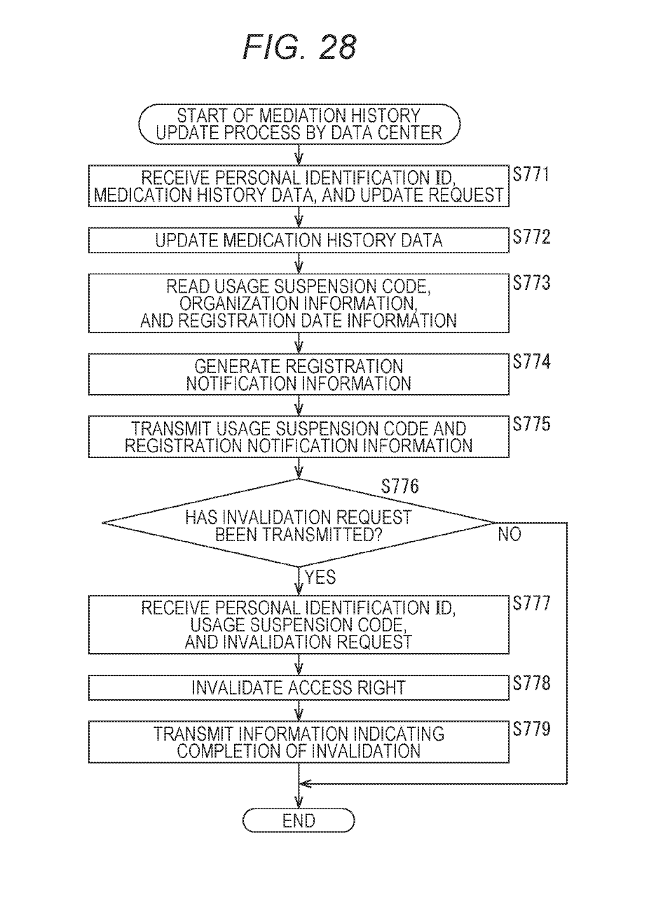

In a case where the access right is managed with the viewing permission/prohibition flag as described above, the medication history update request process shown in FIG. 27 and the medication history update process shown in FIG. 28 are performed.

Referring now to the flowcharts in FIGS. 27 and 28, the medication history update request process and the medication history update process that are processes related to updating of medication history data and a registration notification to the user are described.

Referring first to the flowchart in FIG. 27, the medication history update request process to be performed by the member store terminal device 12 is described. It should be noted that the procedures in steps S731 through S735 are similar to the procedures in steps S101 through S105 in FIG. 9, and therefore, explanation of them is not repeated herein.

After a usage suspension code and registration notification information are displayed in step S735, and the user or the like checks the new registration, a pharmacist or the like issues an instruction for an appropriate process by operating the input unit 83. For example, in a case where the new registration indicated by the registration notification information is an unauthorized registration not permitted by the user, the pharmacist or the like issues an instruction to invalidate the access right related to the registration.

In step S736, the request processing unit 92 determines whether to invalidate the access right related to the usage suspension code sent with the registration notification information, in accordance with a signal supplied from the input unit 83 in response to the operation performed by the pharmacist or the like.

If the access right is determined not to be invalidated in step S736, or if the new registration about which a notification has been sent with the registration notification information is a registration permitted by the user, the process moves on to step S737. After that, the procedures in steps S737 and S738 are then carried out, and the medication history update request process then comes to an end. However, these procedures are similar to the procedures in steps S107 and S108 in FIG. 9, and therefore, explanation of them is not repeated herein.

If the access right related to the usage suspension code sent with the registration notification information is determined to be invalidated in step S736, on the other hand, the communication unit 82 in step S739 transmits the personal identification ID, the usage suspension code, and an invalidation request to the data center 11.

Specifically, in accordance with an operation performed by the pharmacist or the like, the request processing unit 92 generates the invalidation request to request invalidation of the medication history data access right of the mobile terminal device identified by the usage suspension code.

The request processing unit 92 also supplies the communication unit 82 with the personal identification ID obtained in step S731, the usage suspension code received in step S734, and the generated invalidation request, and instructs the communication unit 82 to transmit the personal identification ID, the usage suspension code, and the invalidation request to the data center 11. The communication unit 82 then transmits the personal identification ID, the usage suspension code, and the invalidation request supplied from the request processing unit 92, to the data center 11 via the communication network 16.

In the data center 11, the access right is invalidated in accordance with the invalidation request. Then, after the invalidation is completed, information indicating the completion of the invalidation is transmitted from the data center 11. For example, the information indicating the completion of the invalidation also includes the usage suspension code of the mobile terminal device having its access right invalidated.

In step S740, the communication unit 82 receives the information that has been transmitted from the data center 11 and indicates the completion of the invalidation, and supplies the information to the control unit 85. The display control unit 95 supplies the display unit 84 with the information supplied from the communication unit 82, and causes the display unit 84 to display the information. The medication history update request process then comes to an end.

In the above manner, the member store terminal device 12 receives and displays the usage suspension code and the registration notification information about the newly registered mobile terminal device when the medication history data is updated.

With this, the user can be made to check the new registration of the mobile terminal device without fail, and a function to protect against registration of a malicious third party can be achieved. As a result, security can be improved.

Referring now to the flowchart in FIG. 28, the medication history update process to be performed by the data center 11 is described. It should be noted that the procedures in steps S771 through S775 are similar to the procedures in steps S141 through S145 in FIG. 10, and therefore, explanation of them is not repeated herein.

In step S776, the management unit 51 determines whether an invalidation request has been transmitted.

If it is determined in step S776 that any invalidation request has not been transmitted, the medication history update process comes to an end.

If it is determined in step S776 that an invalidation request has been transmitted, on the other hand, the communication unit 42 in step S777 receives the personal identification ID, the usage suspension code, and the invalidation request transmitted from the member store terminal device 12, and supplies the control unit 43 with the personal identification ID, the usage suspension code, and the invalidation request. The personal identification ID, the usage suspension code, and the invalidation request received in step S777 have been transmitted in step S739 in FIG. 27.

In step S778, the management unit 51 invalidates the access right, in accordance with the personal identification ID, the usage suspension code, and the invalidation request supplied from the communication unit 42.

Specifically, in accordance with the invalidation request, the management unit 51 causes the recording unit 41 to change the value of the viewing permission/prohibition flag associated with the individual-based terminal ID and the personally-set terminal code that constitute the received usage suspension code to “0”, among the individual-based terminal IDs and the personally-set terminal codes associated with the received personal identification ID. In accordance with the instruction from the management unit 51, the recording unit 41 switches the value of the viewing permission/prohibition flag to “0”, to invalidate the access right.

After the access right is invalidated, the management unit 51 supplies the communication unit 42 with information indicating the completion of the invalidation. For example, the information indicating the completion of the invalidation also includes the usage suspension code of the mobile terminal device that has been stopped from using services or has its access right invalidated.

In step S779, the communication unit 42 transmits the information that has been supplied from the management unit 51 and indicates the completion of the invalidation, to the member store terminal device 12 via the communication network 16. The medication history update process then comes to an end.

In a case where the medication history data associated with the personal identification ID is updated, if there is a usage suspension code for which any registration notification has not been sent to the user, the data center 11 generates registration notification information with respect to the usage suspension code as described above, and sends a registration notification. When there is a new registration, the user is notified of the registration as described above, so that unauthorized viewing of the medication history data can be prevented, and security can be improved.

Further, although medication history data in a computerized medication record is viewed in the above described examples, the present technology can be applied in cases where information about each individual is viewed, or where information about a person is disclosed only within a specific range. Particularly, the present technology is useful as a mechanism for managing changes in the information disclosure range, without any personal information about users being recorded in a server equivalent to the data center 11. Also, some or all of the functions of the data center 11 described so far may not be provided in the data center 11 but may be given to the member store terminal device 12 or the like, which is a registration terminal device that registers mobile terminal devices.

Meanwhile, the above-described series of processes may be performed by hardware or may be performed by software. Where the series of processes are to be performed by software, the program that forms the software is installed into a computer. Here, the computer may be a computer incorporated into special-purpose hardware, or may be a general-purpose computer that can execute various kinds of functions if various kinds of programs are installed thereinto.

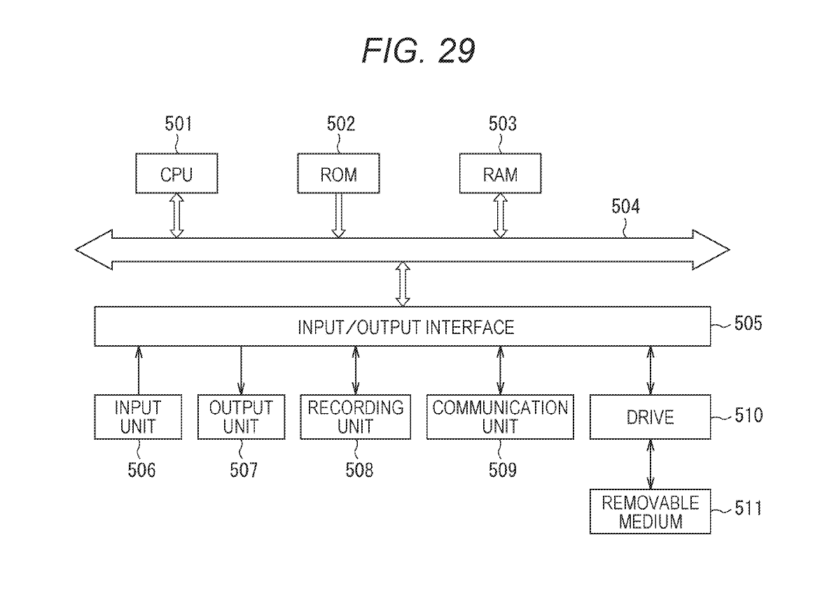

FIG. 29 is a block diagram showing an example configuration of the hardware of a computer that performs the above-described series of processes in accordance with a program.

In the computer, a central processing unit (CPU) 501, a read only memory (ROM) 502, and a random access memory (RAM) 503 are connected to one another by a bus 504.

An input/output interface 505 is further connected to the bus 504. An input unit 506, an output unit 507, a recording unit 508, a communication unit 509, and a drive 510 are connected to the input/output interface 505.

The input unit 506 is formed with a keyboard, a mouse, a microphone, an imaging device, and the like. The output unit 507 is formed with a display, a speaker, and the like. The recording unit 508 is formed with a hard disk, a nonvolatile memory, or the like. The communication unit 509 is formed with a network interface or the like. The drive 510 drives a removable medium 511, such as a magnetic disk, an optical disk, a magneto optical disk, or a semiconductor memory.

In the computer designed as above, the CPU 501 loads a program recorded in the recording unit 508 into the RAM 503 via the input/output interface 505 and the bus 504, for example, and executes the program, so that the above-described series of processes are performed.

The program to be executed by the computer (the CPU 501) may be recorded on the removable medium 511 as a packaged medium to be provided, for example. Alternatively, the program can be provided via a wired or wireless transmission medium, such as a local area network, the Internet, or digital satellite broadcasting.

In the computer, the program can be installed into the recording unit 508 via the input/output interface 505 when the removable medium 511 is mounted on the drive 510. The program can also be received by the communication unit 509 via a wired or wireless transmission medium, and be installed into the recording unit 508. Alternatively, the program may be installed beforehand into the ROM 502 or the recording unit 508.

It should be noted that the program to be executed by the computer may be a program for performing processes in chronological order in accordance with the sequence described in this specification, or may be a program for performing processes in parallel or performing a process when necessary, such as when there is a call.

It should be noted that embodiments of the present technology are not limited to the above-described embodiments, and various modifications may be made to them without departing from the scope of the present technology.

For example, the present technology can be embodied in a cloud computing configuration in which one function is shared among devices via a network, and processing is performed by the devices cooperating with one another.

In addition, the respective steps described with reference to the above described flowcharts can be carried out by one device or can be shared among devices.

Further, in a case where more than one process is included in one step, the processes included in the step can be performed by one device or can be shared among devices.

In addition, the advantageous effects described in this specification are merely examples, and the advantageous effects of the present technology are not limited to them and may include other effects.

Further, the present technology may take the following forms.

(1)

A medication history information management device connected to registration terminal devices and viewing terminal devices via a communication network,

the medication history information management device including:

a communication unit that transmits and receives information;

a recording unit that records at least medication history information and terminal identification information about a viewing terminal device allowed to view the medication history information, the medication history information and the terminal identification information being associated with personal identification information; and

a control unit that controls the communication unit and the recording unit,

wherein,

when the communication unit receives, from the registration terminal device, the personal identification information, registration-related information, and a request for registration of a first viewing terminal device as a viewing terminal device allowed to view the medication history information associated with the personal identification information,

the control unit performs:

a process of generating first terminal identification information for identifying the first viewing terminal device;

a process of associating the first terminal identification information and the registration-related information with the personal identification information, and recording the first terminal identification information and the registration-related information into the recording unit; and

a process of transmitting response information including the first terminal identification information from the communication unit to the registration terminal device, the response information indicating that the first viewing terminal device is registered as a viewing terminal device allowed to view the medication history information associated with the personal identification information, and,

when the communication unit receives a request for viewing of the medication history information from a second viewing terminal device, the control unit performs a process of transmitting the medication history information with which the second viewing terminal device is associated as a viewing terminal device allowed to view the medication history information, the medication history information being transmitted from the communication unit to the second viewing terminal device.

(2)

The medication history information management device of (1), wherein the registration-related information includes identification information corresponding to a place where the registration request has been issued by operating the registration terminal device, the identification information being generated as information about a place where the first viewing terminal device has been registered.

(3)

The medication history information management device of (1) or (2), wherein, when the communication unit receives a request for registration of information about the first viewing terminal device registered in the recording unit in accordance with the registration request, the control unit performs a process of associating the received information about the first viewing terminal device with the first terminal identification information associated and recorded with the personal identification information, and recording the information about the first viewing terminal device into the recording unit.

(4)

The medication history information management device of (3), wherein the information about the first viewing terminal device includes information from which the owner of the first viewing terminal device can be identified.

(5)

The medication history information management device of any of (1) through (4), wherein,

when second terminal identification information for identifying the second viewing terminal device is associated with the personal identification information, a viewing terminal device allowed to view the medication history information associated with the personal identification information is newly registered, information indicating that the second viewing terminal device is a viewing terminal device issuing a notification of the new registration of the viewing terminal device is recorded in the recording unit, and when the second viewing terminal device further accesses the communication unit,

the control unit performs a process of transmitting registration notification information about the viewing terminal device registered as a viewing terminal device allowed to view the medication history information associated with the personal identification information, the registration notification information being transmitted from the communication unit to the second viewing terminal device.

(6)

The medication history information management device of (5), wherein,

when the communication unit receives the personal identification information, the registration-related information, and a request for registration of the first viewing terminal device as a viewing terminal device allowed to view the medication history information associated with the personal identification information,

the control unit further performs:

a process of generating registration date information; and

a process of associating the registration date information with the personal identification information, and recording the registration date information into the recording unit.

(7)

The medication history information management device of (6), wherein the registration notification information includes the registration-related information and the registration date information.

(8)

The medication history information management device of any of (1) through (4), wherein,

when a request for updating of the medication history information associated with the personal identification information is received from the registration terminal device,

the control unit performs:

a process of updating the medication history information associated with the personal identification information; and

a process of transmitting registration notification information indicating that the first viewing terminal device is associated with the first terminal identification information and is registered, the registration notification information being transmitted from the communication unit to the registration terminal device.

(9)

The medication history information management device of (8), wherein

the control unit further performs

a process of recording, into the recording unit, information indicating whether the registration notification information has been transmitted, and,

when the registration notification information has been transmitted to the registration terminal device, the control unit updates the information indicating whether the registration notification information has been transmitted.

(10)

The medication history information management device of (1), wherein, when the communication unit receives a request for invalidation of a right of the first viewing terminal device to view the medication history information associated with the personal identification information, the control unit performs a process of invalidating the right of the first viewing terminal device to view the medication history information.

(11)

The medication history information management device of (10), wherein the control unit performs the process of invalidating the right of the first viewing terminal device to view the medication history information by changing information indicating permission/prohibition of viewing by the first viewing terminal device, the information being recorded and associated with the personal identification information.

(12)

The medication history information management device of (1), wherein, when the communication unit receives a request for transmission of a list of information about the viewing terminal device associated with the personal identification information, the control unit performs a process of transmitting, from the communication unit, the list of the information about the viewing terminal device associated with the personal identification information.

(13)

A medication history information management method implemented in a medication history information management device connected to registration terminal devices and viewing terminal devices via a communication network,

the medication history information management device including:

a communication unit that transmits and receives information;

a recording unit that records at least medication history information and terminal identification information about a viewing terminal device allowed to view the medication history information, the medication history information and the terminal identification information being associated with personal identification information; and

a control unit that controls the communication unit and the recording unit,

the medication history information management method including the steps of:

when the communication unit receives, from the registration terminal device, the personal identification information, registration-related information, and a request for registration of a first viewing terminal device as a viewing terminal device allowed to view the medication history information associated with the personal identification information,

the control unit performing a process of generating the terminal identification information for identifying the first viewing terminal device;

the control unit performing a process of associating the terminal identification information and the registration-related information with the personal identification information, and recording the terminal identification information and the registration-related information into the recording unit; and

the control unit performing a process of transmitting response information containing the terminal identification information from the communication unit to the registration terminal device, the response information indicating that the first viewing terminal device is registered as a viewing terminal device allowed to view the medication history information associated with the personal identification information; and,

when the communication unit receives a request for viewing of the medication history information from a second viewing terminal device,

the control unit performing a process of transmitting the medication history information with which the second viewing terminal device is associated as a viewing terminal device allowed to view the medication history information, the medication history information being transmitted from the communication unit to the second viewing terminal device.

(14)

A program to be executed in a computer that controls a medication history information management device connected to registration terminal devices and viewing terminal devices via a communication network,

the medication history information management device including:

a communication unit that transmits and receives information; and

a recording unit that records at least medication history information and terminal identification information about a viewing terminal device allowed to view the medication history information, the medication history information and the terminal identification information being associated with personal identification information,

the program causing the computer to perform a process including the steps of:

when the communication unit receives, from the registration terminal device, the personal identification information, registration-related information, and a request for registration of a first viewing terminal device as a viewing terminal device allowed to view the medication history information associated with the personal identification information,

performing a process of generating the terminal identification information for identifying the first viewing terminal device;

performing a process of associating the terminal identification information and the registration-related information with the personal identification information, and recording the terminal identification information and the registration-related information into the recording unit; and

performing a process of transmitting response information including the terminal identification information from the communication unit to the registration terminal device, the response information indicating that the first viewing terminal device is registered as a viewing terminal device allowed to view the medication history information associated with the personal identification information; and,

when the communication unit receives a request for viewing of the medication history information from a second viewing terminal device,

performing a process of transmitting the medication history information with which the second viewing terminal device is associated as a viewing terminal device allowed to view the medication history information, the medication history information being transmitted from the communication unit to the second viewing terminal device.

(15)

A registration terminal device connected to a medication history information management device via a communication network,

the registration terminal device including:

a communication unit that transmits and receives information via the communication network; and

a control unit that controls the communication unit,

wherein the control unit performs:

a process of transmitting first personal identification information, registration-related information, and a request for registration of a first viewing terminal device as a viewing terminal device allowed to view medication history information associated with the first personal identification information, the transmission being from the communication unit to the medication history information management device; and

a process of receiving response information including terminal identification information from the medication history information management device, and displaying the terminal identification information, the response information indicating that the first viewing terminal device is registered in response to the request as a viewing terminal device allowed to view the medication history information associated with the first personal identification information.

(16)

The registration terminal device of (15), wherein:

the control unit performs a process of transmitting second personal identification information and a request for viewing or updating of the medication history information associated with the second personal identification information, the transmission being from the communication unit to the medication history information management device; and,

when registration notification information about a second viewing terminal device associated with the second personal identification information is received from the medication history information management device in response to the request for viewing or updating,

the control unit performs:

a process of displaying the registration notification information about the second viewing terminal device; and

a process of transmitting information about the second viewing terminal device to the medication history information management device, or recording the information about the second viewing terminal device into a source of the second personal identification information.

(17)

A registration method implemented in a registration terminal device connected to a medication history information management device via a communication network,

the registration terminal device including:

a communication unit that transmits and receives information via the communication network; and

a control unit that controls the communication unit,

the registration method including the steps of:

the control unit performing a process of transmitting personal identification information, registration-related information, and a request for registration of a predetermined viewing terminal device as a viewing terminal device allowed to view medication history information associated with the personal identification information, the transmission being from the communication unit to the medication history information management device; and

the control unit performing a process of receiving response information including terminal identification information from the medication history information management device, and displaying the terminal identification information, the response information indicating that the predetermined viewing terminal device is registered in response to the request as a viewing terminal device allowed to view the medication history information associated with the personal identification information.

(18)

A program to be executed in a computer that controls a registration terminal device connected to a medication history information management device via a communication network, the registration terminal device including a communication unit that transmits and receives information via the communication network,

the program causing the computer to perform a process including the steps of:

performing a process of transmitting personal identification information, registration-related information, and a request for registration of a predetermined viewing terminal device as a viewing terminal device allowed to view medication history information associated with the personal identification information, the transmission being from the communication unit to the medication history information management device; and

performing a process of receiving response information including terminal identification information from the medication history information management device, and displaying the terminal identification information, the response information indicating that the predetermined viewing terminal device is registered in response to the request as a viewing terminal device allowed to view the medication history information associated with the personal identification information.

### REFERENCE SIGNS LIST

11 Data center
12 Member store terminal device
13 IC card
14 Mobile terminal device
15 Mobile terminal device
42 Communication unit
51 Management unit
52 Generation unit
81 Reader/writer
82 Communication unit
91 Code generation unit
92 Request processing unit
93 Recording control unit
94 Data generation unit
95 Display control unit
111 Communication unit
112 Short-range communication unit
122 Information management unit
123 Viewing control unit
124 Display control unit

1. A medication history information management device connected to a plurality of registration terminal devices and a plurality of viewing terminal devices via a communication network,
the medication history information management device comprising:
a communication unit configured to transmit and receive information;
a recording unit configured to record at least medication history information and terminal identification information about a viewing terminal device allowed to view the medication history information, the medication history information and the terminal identification information being associated with personal identification information; and
a control unit configured to control the communication unit and the recording unit,
wherein,
when the communication unit receives, from the registration terminal device, the personal identification information, registration-related information, and a request for registration of a first viewing terminal device as a viewing terminal device allowed to view the medication history information associated with the personal identification information,
the control unit performs:
a process of generating first terminal identification information for identifying the first viewing terminal device;
a process of associating the first terminal identification information and the registration-related information with the personal identification information, and recording the first terminal identification information and the registration-related information into the recording unit; and
a process of transmitting response information including the first terminal identification information from the communication unit to the registration terminal device, the response information indicating that the first viewing terminal device is registered as a viewing terminal device allowed to view the medication history information associated with the personal identification information, and,
when the communication unit receives a request for viewing of the medication history information from a second viewing terminal device, the control unit performs a process of transmitting the medication history information with which the second viewing terminal device is associated as a viewing terminal device allowed to view the medication history information, the medication history information being transmitted from the communication unit to the second viewing terminal device.

2. The medication history information management device according to claim 1, wherein the registration-related information includes identification information corresponding to a place where the registration request has been issued by operating the registration terminal device, the identification information being generated as information about a place where the first viewing terminal device has been registered.

3. The medication history information management device according to claim 1, wherein, when the communication unit receives a request for registration of information about the first viewing terminal device registered in the recording unit in accordance with the registration request, the control unit performs a process of associating the received information about the first viewing terminal device with the first terminal identification information associated and recorded with the personal identification information, and recording the information about the first viewing terminal device into the recording unit.

4. The medication history information management device according to claim 3, wherein the information about the first viewing terminal device includes information from which an owner of the first viewing terminal device can be identified.

5. The medication history information management device according to claim 1, wherein,
when second terminal identification information for identifying the second viewing terminal device is associated with the personal identification information, a viewing terminal device allowed to view the medication history information associated with the personal identification information is newly registered, information indicating that the second viewing terminal device is a viewing terminal device issuing a notification of the new registration of the viewing terminal device is recorded in the recording unit, and when the second viewing terminal device further accesses the communication unit,
the control unit performs a process of transmitting registration notification information about the viewing terminal device registered as a viewing terminal device allowed to view the medication history information associated with the personal identification information, the registration notification information being transmitted from the communication unit to the second viewing terminal device.

6. The medication history information management device according to claim 5, wherein,
when the communication unit receives the personal identification information, the registration-related information, and a request for registration of the first viewing terminal device as a viewing terminal device allowed to view the medication history information associated with the personal identification information,
the control unit further performs:
a process of generating registration date information; and
a process of associating the registration date information with the personal identification information, and recording the registration date information into the recording unit.

7. The medication history information management device according to claim 6, wherein the registration notification information includes the registration-related information and the registration date information.

8. The medication history information management device according to claim 1, wherein,
when a request for updating of the medication history information associated with the personal identification information is received from the registration terminal device,
the control unit performs:
a process of updating the medication history information associated with the personal identification information; and
a process of transmitting registration notification information indicating that the first viewing terminal device is associated with the first terminal identification information and is registered, the registration notification information being transmitted from the communication unit to the registration terminal device.

9. The medication history information management device according to claim 8, wherein
the control unit further performs
a process of recording, into the recording unit, information indicating whether the registration notification information has been transmitted, and,
when the registration notification information has been transmitted to the registration terminal device, the control unit updates the information indicating whether the registration notification information has been transmitted.

10. The medication history information management device according to claim 1, wherein, when the communication unit receives a request for invalidation of a right of the first viewing terminal device to view the medication history information associated with the personal identification information, the control unit performs a process of invalidating the right of the first viewing terminal device to view the medication history information.

11. The medication history information management device according to claim 10, wherein the control unit performs the process of invalidating the right of the first viewing terminal device to view the medication history information by changing information indicating permission/prohibition of viewing by the first viewing terminal device, the information being recorded and associated with the personal identification information.

12. The medication history information management device according to claim 1, wherein, when the communication unit receives a request for transmission of a list of information about the viewing terminal device associated with the personal identification information, the control unit performs a process of transmitting, from the communication unit, the list of the information about the viewing terminal device associated with the personal identification information.

13. A medication history information management method implemented in a medication history information management device connected to a plurality of registration terminal devices and a plurality of viewing terminal devices via a communication network,
the medication history information management device including:
a communication unit configured to transmit and receive information;
a recording unit configured to record at least medication history information and terminal identification information about a viewing terminal device allowed to view the medication history information, the medication history information and the terminal identification information being associated with personal identification information; and
a control unit configured to control the communication unit and the recording unit,
the medication history information management method comprising the steps of:
when the communication unit receives, from the registration terminal device, the personal identification information, registration-related information, and a request for registration of a first viewing terminal device as a viewing terminal device allowed to view the medication history information associated with the personal identification information,
the control unit performing a process of generating the terminal identification information for identifying the first viewing terminal device;
the control unit performing a process of associating the terminal identification information and the registration-related information with the personal identification information, and recording the terminal identification information and the registration-related information into the recording unit; and
the control unit performing a process of transmitting response information including the terminal identification information from the communication unit to the registration terminal device, the response information indicating that the first viewing terminal device is registered as a viewing terminal device allowed to view the medication history information associated with the personal identification information; and,
when the communication unit receives a request for viewing of the medication history information from a second viewing terminal device, the control unit performing a process of transmitting the medication history information with which the second viewing terminal device is associated as a viewing terminal device allowed to view the medication history information, the medication history information being transmitted from the communication unit to the second viewing terminal device.

14. A program to be executed in a computer that controls a medication history information management device connected to a plurality of registration terminal devices and a plurality of viewing terminal devices via a communication network,
the medication history information management device including:
a communication unit configured to transmit and receive information; and
a recording unit configured to record at least medication history information and terminal identification information about a viewing terminal device allowed to view the medication history information, the medication history information and the terminal identification information being associated with personal identification information,
the program causing the computer to perform a process including the steps of:
when the communication unit receives, from the registration terminal device, the personal identification information, registration-related information, and a request for registration of a first viewing terminal device as a viewing terminal device allowed to view the medication history information associated with the personal identification information,
performing a process of generating the terminal identification information for identifying the first viewing terminal device;
performing a process of associating the terminal identification information and the registration-related information with the personal identification information, and recording the terminal identification information and the registration-related information into the recording unit; and
performing a process of transmitting response information including the terminal identification information from the communication unit to the registration terminal device, the response information indicating that the first viewing terminal device is registered as a viewing terminal device allowed to view the medication history information associated with the personal identification information; and,
when the communication unit receives a request for viewing of the medication history information from a second viewing terminal device,
performing a process of transmitting the medication history information with which the second viewing terminal device is associated as a viewing terminal device allowed to view the medication history information, the medication history information being transmitted from the communication unit to the second viewing terminal device.

15. A registration terminal device connected to a medication history information management device via a communication network,
the registration terminal device comprising:
a communication unit configured to transmit and receive information via the communication network; and
a control unit configured to control the communication unit,
wherein the control unit performs:
a process of transmitting first personal identification information, registration-related information, and a request for registration of a first viewing terminal device as a viewing terminal device allowed to view medication history information associated with the first personal identification information, the transmission being from the communication unit to the medication history information management device; and
a process of receiving response information including terminal identification information from the medication history information management device, and displaying the terminal identification information, the response information indicating that the first viewing terminal device is registered in response to the request as a viewing terminal device allowed to view the medication history information associated with the first personal identification information.

16. The registration terminal device according to claim 15, wherein:
the control unit performs a process of transmitting second personal identification information and a request for viewing or updating of the medication history information associated with the second personal identification information, the transmission being from the communication unit to the medication history information management device; and,
when registration notification information about a second viewing terminal device associated with the second personal identification information is received from the medication history information management device in response to the request for viewing or updating,
the control unit performs:
a process of displaying the registration notification information about the second viewing terminal device; and
a process of transmitting information about the second viewing terminal device to the medication history information management device, or recording the information about the second viewing terminal device into a source of the second personal identification information.

17. A registration method implemented in a registration terminal device connected to a medication history information management device via a communication network,
the registration terminal device including:
a communication unit configured to transmit and receive information via the communication network; and
a control unit configured to control the communication unit,
the registration method comprising the steps of:
the control unit performing a process of transmitting personal identification information, registration-related information, and a request for registration of a predetermined viewing terminal device as a viewing terminal device allowed to view medication history information associated with the personal identification information, the transmission being from the communication unit to the medication history information management device; and
the control unit performing a process of receiving response information including terminal identification information from the medication history information management device, and displaying the terminal identification information, the response information indicating that the predetermined viewing terminal device is registered in response to the request as a viewing terminal device allowed to view the medication history information associated with the personal identification information.

18. A program to be executed in a computer that controls a registration terminal device connected to a medication history information management device via a communication network, the registration terminal device including a communication unit configured to transmit and receive information via the communication network,
the program causing the computer to perform a process including the steps of:
performing a process of transmitting personal identification information, registration-related information, and a request for registration of a predetermined viewing terminal device as a viewing terminal device allowed to view medication history information associated with the personal identification information, the transmission being from the communication unit to the medication history information management device; and
performing a process of receiving response information including terminal identification information from the medication history information management device, and displaying the terminal identification information, the response information indicating that the predetermined viewing terminal device is registered in response to the request as a viewing terminal device allowed to view the medication history information associated with the personal identification information.
